(19) United States
(12) Patent Application Publication
(10) Pub. No.: US 2025/0094811 A1
(43) Pub. Date: Mar. 20, 2025

(54) Analyzing an inference of a machine learning predictor

(71) Applicant: Fraunhofer-Gesellschaft zur Förderung der angewandten Forschung e.V., München (DE)

(72) Inventors: Reduan ACHTIBAT, Berlin (DE); Maximilian DREYER, Berlin (DE); Ilona EISENBRAUN, Berlin (DE); Sebastian BOSSE, Berlin (DE); Thomas WIEGAND, Berlin (DE); Wojciech SAMEK, Berlin (DE); Sebastian LAPUSCHKIN, Berlin (DE)

(21) Appl. No.: 18/966,574

(22) Filed: Dec. 3, 2024

Related U.S. Application Data
(63) Continuation of application No. PCT/EP2023/065138, filed on Jun. 6, 2023.

(30) Foreign Application Priority Data
Jun. 6, 2022 (EP) 22177382.3

(51) Int. Cl. G06N 3/084

(52) U.S. Cl. CPC G06N 3/084

(57) ABSTRACT

A relevance score for a predictor portion of a machine learning predictor is determined by performing a reverse propagation of an initial relevance score, which is attributed to a first predetermined predictor portion, along propagation paths of the machine learning predictor, and by filtering the reverse propagation with respect to a second predetermined predictor portion. Furthermore, respective affiliation scores for a set of data structures with respect to a predictor portion of a machine learning predictor are determined by performing reverse propagations of an initial relevance score from a first predetermined predictor portion to the predictor portion.

### CROSS-REFERENCES TO RELATED APPLICATIONS

This application is a continuation of copending International Application No. PCT/EP2023/065138, filed Jun. 6, 2023, which is incorporated herein by reference in its entirety, and additionally claims priority from European Application No. EP 22 177 382.3, filed Jun. 6, 2022, which is incorporated herein by reference in its entirety.

Embodiments of the present inventions relate to apparatuses and methods for handling, or analyzing, an inference performed by a machine learning (ML) predictor. Some embodiments relate to apparatuses and methods for providing information for revealing concepts or meaningfulness an inference performed by a ML predictor. Some embodiments relate to Human-Understandable Explanations of ML predictors through Concept Relevance Propagation.

### BACKGROUND OF THE INVENTION

ML predictors are widely used for processing or analyzing data, e.g. in classifying a sample of input data. To this end, the ML predictor may apply a trained model, which was previously learned on a set of training data, to the input data to obtain a result or decision, e.g., referred to as inference. As such, the inference of a ML predictor depends on the set of training data, and in particular, the ML predictor may be regarded as kind of a “black bock”, because it is not obvious, how a particular decision emerges from the input data, i.e., what the reasoning of the ML predictor relies on. However, understanding decisions of ML predictors may be important for the reliability and reliable applicability of such structures. For example, the analysis of a ML predictor may be used for correcting the underlying model to increase the reliability of the ML predictor, or for increasing the efficiency of the ML predictor, e.g. by pruning.

Therefore, a concept allowing for analyzing an inference of an ML predictor on a data structure is desirable, which gives information about the inference, which information may allow for increasing the reliability and/or the computational efficiency of the ML predictor.

### SUMMARY

An embodiment may have an apparatus, configured for assigning a relevance score to a predictor portion, PP, of a machine learning, ML, predictor for performing an inference on a data structure, the relevance score indicating a share with which propagation paths, which connect the PP with a first predetermined PP of the ML predictor, contribute to an activation of the first predetermined PP, which activation is associated with the inference performed by the ML predictor on the data structure, wherein the apparatus is configured for determining the relevance score for the PP by performing a reverse propagation of an initial relevance score, which is attributed to the first predetermined PP, along the propagation paths, and filtering the reverse propagation by weighting a first propagation path through the ML predictor, the first propagation path passing through a second predetermined PP of the ML predictor, differently than a second propagation path through the ML predictor, the second propagation path circumventing the second predetermined PP.

Another embodiment may have an apparatus, configured for assigning a relevance score to a portion of a data structure, the relevance score rating a relevance of the portion for an inference performed by a machine learning predictor on the data structure, wherein the apparatus is configured for determining the relevance score for the portion by performing a reverse propagation of an initial relevance score, which is attributed to a first predetermined predictor portion of the ML predictor, from the first predetermined PP through the ML predictor onto the portion of the data structure, filtering the reverse propagation by weighting a first propagation path through the ML predictor, the first propagation path passing through a second predetermined PP of the ML predictor, differently than a second propagation path through the ML predictor, the second propagation path circumventing the second predetermined PP.

Another embodiment may have an apparatus, configured for determining, for each out of a set of data structures, an affiliation score with respect to a concept associated with a predictor portion of a machine learning predictor by determining a relevance score for the PP with respect to an inference performed by the ML predictor on the respective data structure, wherein the relevance score indicates a contribution of the PP to an activation of a first predetermined PP of the ML predictor, which activation is associated with the inference performed by the ML predictor on the data structure, wherein the apparatus is configured for determining the relevance score by performing a reverse propagation of an initial relevance score from the first predetermined PP to the PP.

Another embodiment may have a method, comprising: assigning a relevance score to a portion of a data structure, the relevance score rating a relevance of the portion for an inference performed by a machine learning predictor on the data structure, wherein the method comprises determining the relevance score for the portion by performing a reverse propagation of an initial relevance score, which is attributed to a first predetermined predictor portion of the ML predictor, from the first predetermined PP through the ML predictor onto the portion of the data structure, filtering the reverse propagation by weighting a first propagation path through the ML predictor, the first propagation path passing through a second predetermined PP of the ML predictor, differently than a second propagation path through the ML predictor, the second propagation path circumventing the second predetermined PP.

Another embodiment may have a method, comprising: assigning a relevance score to a predictor portion of a ML predictor for performing an inference on a data structure, the relevance score indicating a share with which propagation paths, which connect the PP with a first predetermined PP of the ML predictor, contribute to an activation of the first predetermined PP, which activation is associated with the inference performed by the ML predictor on the data structure, wherein the method comprises determining the relevance score for the PP by performing a reverse propagation of an initial relevance score, which is attributed to the first predetermined PP, along the propagation paths, and filtering the reverse propagation by weighting a first propagation path through the ML predictor, the first propagation path passing through a second predetermined PP of the ML predictor, differently than a second propagation path through the ML predictor, the second propagation path circumventing the second predetermined PP.

Another embodiment may have a method, comprising: determining, for each out of a set of data structures, an affiliation score with respect to a concept associated with a predictor portion of a machine learning predictor by determining a relevance score for the PP with respect to an inference performed by the ML predictor on the respective data structure, wherein the relevance score indicates a contribution of the PP to an activation of a first predetermined PP of the ML predictor, which activation is associated with the inference performed by the ML predictor on the data structure, wherein the method comprises determining the relevance score by performing a reverse propagation of an initial relevance score from the first predetermined PP to the PP.

Another embodiment may have a non-transitory digital storage medium having a computer program stored thereon to perform the methods according to the invention when said computer program is run by a computer.

Embodiments of a first aspect of the present invention rely on the idea to assign a relevance score to a portion of an ML predictor, or to a portion of a data structure serving as input to the ML predictor, the relevance score indicating a relevance of the portion with respect to a result of an inference performed by the ML predictor on the data structure, or indicating a relevance of the portion with respect to an activation of a first predetermined predictor portion of the ML predictor in an inference performed by the ML predictor on the data structure. To this end, the relevance score is determined by reversely propagating an initial relevance score from a first predetermined predictor portion of the ML predictor to the portion (of the ML predictor or the data structure), wherein the reverse propagation is filtered with respect to a second predetermined predictor portion, i.e., the reverse propagation differentiates between propagation paths passing or not passing through the second predetermined predictor portion. Doing so may reveal information about the second predetermined predictor portion, e.g. about a relevance the portion, for which the relevance score is determined, with respect to the second predetermined predictor portion. For example, such information may be used to analyze a concept represented by the second predetermined predictor portion. In this respect, the term “concept” may refer to characteristics of a content, to which a predictor portion is sensitive, i.e. in response to which it activates. The filtered reverse propagation allows for revealing, which portions of a data structure, or which upstream portions of the ML predictor are relevant for the activation of the first predetermined predictor portion. For example, in this respect, relevant sub-concepts of a concept attributed to the second predetermined predictor portions may be analyzed. These findings in turn allow for finding artifacts in the ML predictor to increase reliability, and/or allow for pruning the ML predictor to increase computational efficiency.

Embodiments of a first aspect of the invention provide, in a first alternative, a method (e.g. for analyzing an inference performed by a ML predictor on a data structure), comprising: assigning a relevance score to a portion of a data structure (e.g. to a pixel of a digital image), the relevance score rating a relevance of the portion for an inference performed by a ML predictor (e.g., an artificial neural network (NN)) on the data structure (e.g., the inference being the network output of applying the NN to the data structure) (e.g., the relevance score indicating a share with which propagation paths, which connect the portion with the first predetermined PP, contribute to an activation of the first predetermined PP, which activation is associated with the inference), wherein the method comprises determining the relevance score for the portion by performing a reverse propagation of an initial relevance score, which is attributed to a first predetermined predictor portion (PP) of the ML predictor, from the first predetermined PP through the ML predictor (or along propagation paths of the ML predictor) onto the portion of the data structure, and by filtering the reverse propagation by weighting a first propagation path through the ML predictor, the first propagation path passing through a second predetermined PP (E.g., a set of one or more units or neurons; E.g., the second predetermined PP is upstream relative to the first predetermined PP with respect to a forward propagation direction (e.g., used for inference) of the ML predictor) of the ML predictor, differently than a second propagation path through the ML predictor, the second propagation path circumventing (or not passing through) the second predetermined PP (e.g., the propagation paths connecting the portion with the first predetermined PP; e.g., the apparatus derives the relevance score by aggregating relevance values resulting from reversely propagating the initial relevance value along propagation paths connecting the first predetermined PP and the portion of the data structure).

Further embodiments of the first aspect of the invention provide, in a second alternative, a method (e.g. for analyzing an inference performed by a ML predictor on a data structure), comprising: assigning a relevance score to a predictor portion (PP) (e.g. a target PP) of a ML predictor (e.g., an artificial neural network (NN)) for performing an inference on a data structure (e.g., a inference on the data structure), the relevance score indicating a share with which propagation paths, which connect the PP (e.g. the target PP) with a first predetermined PP of the ML predictor, contribute to an activation of the first predetermined PP, which activation is associated with the inference performed by the ML predictor on the data structure, wherein the method comprises determining the relevance score for the PP by performing a reverse propagation of an initial relevance score, which is attributed to the first predetermined PP, along the propagation paths, and by filtering the reverse propagation by weighting a first propagation path through the ML predictor, the first propagation path passing through a second predetermined PP (e.g., a set of one or more units or neurons) of the ML predictor, differently than a second propagation path through the ML predictor, the second propagation path circumventing (or not passing through) the second predetermined PP (e.g., the propagation paths connecting the (target) PP with the first predetermined PP; e.g., the apparatus derives the relevance score by aggregating relevance values resulting from reversely propagating the initial relevance value along propagation paths connecting the first predetermined PP and the (target) PP).

For example, the predictor portion, to which the relevance score is assigned, may be a filter or a channel, or part of a channel of the ML predictor, e.g. an intermediate channel, i.e., a channel between an input channel and an output channel of the ML predictor. In examples, the channel may be the input channel, and in this respect, the predictor portion may relate to a portion of the data structure, being input to the ML predictor. In this respect, it is clear that the portion of the first alternative of the first aspect may be regarded as a predictor portion in the sense of the second alternative.

Embodiments according to a second aspect rely on the idea to measure an affiliation of each of a set of data structures with respect to a predictor portion of an ML predictor, or to a concept (E.g. a concept as introduced above) associated with the predictor portion, by using a relevance score, which measures a contribution of the relevance score in a prediction performed on the respective data set. In other words, the data structures may be rated with respect to a relevance of the predictor portion for the inferences performed on the respective data structures. Doing so allows for identifying a subset of the set of data structures, which subset is representative of a concept encoded by the predictor portion.

The relevance scores may be performing by a reverse propagation of an initial relevance score of a first predetermined predictor portion to the considered predictor portion, e.g., as described with respect to embodiments of the first aspect. By using the reverse propagation for determining the affiliation of the data structures to the predictor portion measure, the affiliation score relies on the actual contribution of the predictor portion to the initial relevance score of the predetermined predictor portion (e.g., an output portion, such as a certain class of a classifying ML predictor). Therefore, in contrast to approaches, which measure the affiliation based on activation of the predictor portion, the disclosed method bases the affiliation on the relevance for a certain inference.

Embodiments according to the second aspect of the invention provide a method (e.g., for analyzing an inference behavior of a machine learning (ML) predictor on a data structure), comprising: determining, for each out of a set of data structures, an affiliation score (or relevance score) with respect to a concept associated with a predictor portion (PP) (e.g., a target PP, e.g. a PP under investigation) of a machine learning (ML) predictor (wherein the concept represents a type of content, to which the predetermined network portion is sensitive, or in response to which the predetermined network portion contributes to a predetermined inference result, or to an activation of a first predetermined PP in an inference of the data structure; E.g., the affiliation score rates, to which extent a content represented in the respective data structure correlates with a the a concept associated with a predetermined predictor portion of an artificial neural network (NN)) by determining a relevance score for the PP with respect to an inference performed by the ML predictor on the respective data structure, wherein the relevance score indicates a contribution of the PP to an activation of a first predetermined PP of the ML predictor, which activation is associated with the inference performed by the ML predictor on the data structure, wherein the method comprises determining the relevance score by performing a reverse propagation of an initial relevance score (which is attributed to the first predetermined PP) from the first predetermined PP to the PP (the target PP).

Further embodiments provide an apparatus configured for performing one or more of the previously described methods.

### BRIEF DESCRIPTION OF THE DRAWINGS

Embodiments of the present invention will be detailed subsequently referring to the appended drawings, in which:

FIG. 1a illustrates an apparatus for assigning a relevance score to a predictor portion according to an embodiment,

FIG. 1b illustrates further details of an embodiment of the apparatus of FIG. 1a,

FIG. 2 illustrates an example of a reverse propagation,

FIG. 3 illustrates an apparatus for determining affiliation scores for data structures according to an embodiment,

FIG. 4 illustrates a further example of the apparatus of FIG. 1a,

FIG. 5 illustrates a further example of the apparatus of FIG. 3,

FIG. 6 illustrates a combination of global XAI and local XAI according to an embodiment,

FIG. 7a-d illustrate how to understand concepts and concept composition according to an embodiment,

FIG. 8a-b illustrates the usage of concept-level explanations for model and data debugging according to an embodiment,

FIG. 9a-b illustrates a method of finding similarity of concepts and analyzing fine-grained decision making according to an embodiment

FIG. 10a-c illustrates an explanation disentanglement according to an embodiment,

FIG. 11a-d illustrates activation-and relevance-based sample selection according to an embodiment,

FIG. 12 illustrates a system for processing a set of items according to an embodiment,

FIG. 13 shows a modification of the system of FIG. 12,

FIG. 14 shows a system for highlighting a region of interest of a set of items according to an embodiment,

FIG. 15 illustrates a system for optimizing a neural network according to an embodiment.

### DETAILED DESCRIPTION OF THE INVENTION

In the following, embodiments are discussed in detail, however, it should be appreciated that the embodiments provide many applicable concepts that can be embodied in a wide variety of coding concepts. The specific embodiments discussed are merely illustrative of specific ways to implement and use the present concept, and do not limit the scope of the embodiments. In the following description, a plurality of details is set forth to provide a more thorough explanation of embodiments of the disclosure. However, it will be apparent to one skilled in the art that other embodiments may be practiced without these specific details. In other instances, well-known structures and devices are shown in form of a block diagram rather than in detail in order to avoid obscuring examples described herein. In addition, features of the different embodiments described herein may be combined with each other, unless specifically noted otherwise. Some embodiments of the present invention are now described in more detail with reference to the accompanying drawings, in which the same or similar elements or elements that have the same or similar have the same reference signs assigned or are identified with the same name.

### SECTION A—EMBODIMENTS

This section describes embodiments of the invention. Further embodiments are described in section B. Furthermore, section B describes embodiments of section A in more detail. In other words, details and features described in section B may optionally be combined with the embodiments of section A, and the advantages described in section B equivalently apply to the embodiments of section A. Applications of the embodiments of section A and B are described in section C. In other words, section C describes embodiments, which make use of the apparatuses and methods described in section A and B and exploit their advantages with respect to exemplary applications.

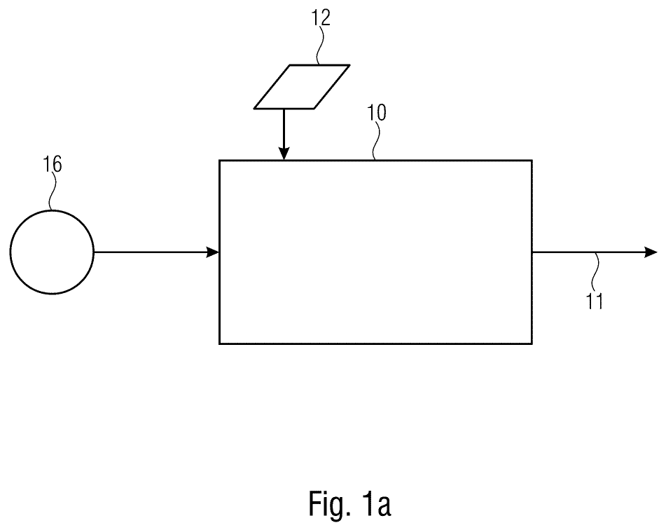

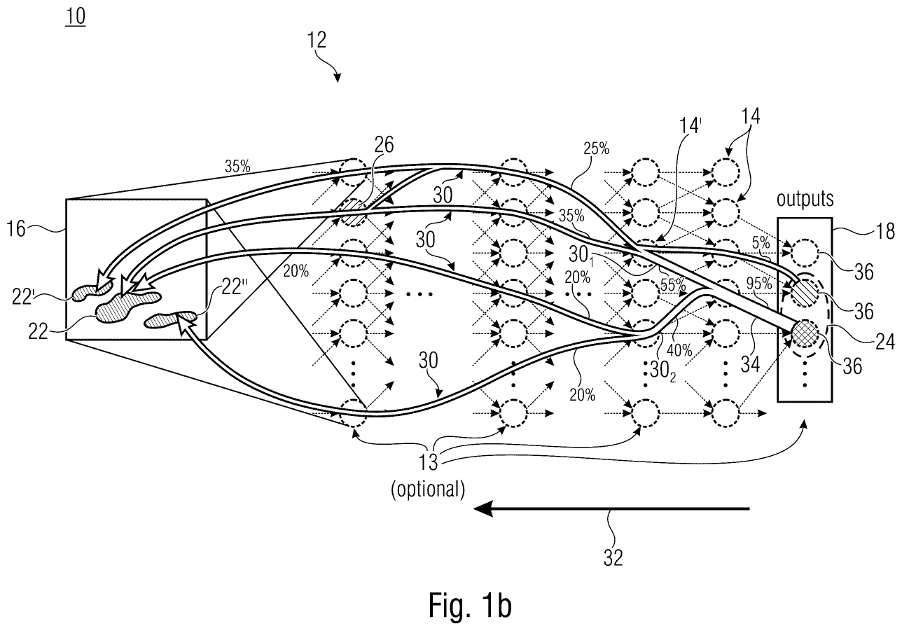

FIG. 1a illustrates an apparatus 10 according to an embodiment. Apparatus 10 is configured for assigning a relevance score 11 to a portion of a data structure 16, or for assigning a relevance score 11 to a predictor portion of an ML predictor 12. Further details of apparatus 10 are described with respect to FIG. 1b.

FIG. 1b illustrates an example of apparatus 10. Apparatus 10 is configured for assigning a relevance score to a portion 22 of a data structure, or for assigning a relevance score to a predictor portion 26 of an ML predictor 12. The relevance score indicates a relevance of the portion 22 or the predictor portion 26 for an inference performed by the ML predictor 12 on the data structure 16. ML predictor 12 is illustrated in FIG. 1b by means of a plurality of predictor portions (PP) 14 (dashed circles in FIG. 1b). It is noted that the number and arrangement of PPs in FIG. 1b is merely illustrative. For example, a PP may be a portion of the ML predictor, which is identifiable in that a mapping of an input of the portion to an output of the portion may be attributed to the portion. For example, the input may be part of the input of the ML predictor or may be provided by a previous portion of the ML predictor. Similarly, the output may represent an output of the ML predictor, or a portion thereof, or the output may be provided to a subsequent portion of the ML predictor. In other words, the ML predictor 12 may be composed of any ML predictor, which can be formulated as directed (acyclic) graphs (DAG) of mappings. Accordingly, applying the ML predictor to the data structure may, for example, involve a sequential application of mappings performed by a plurality of PPs, referred to as forward propagation. An application of the ML predictor 12 on the data structure 16 so as to map the data structure 16 onto an output 18 of the ML predictor may be referred to as inference.

For example, the output 18 may comprise one or more output portions 36, each of which may be represented by an output value or an output vector. In examples, the ML predictor may be for classifying the data structure, and each of the output portions may be associated with a respective class.

It is noted, that a PP may perform a plurality of individual mappings, i.e. a PP may comprise a plurality of units, in examples referred to as nodes or neurons, each unit performing a mapping from an input to an output of the respective unit. E.g., for the example of a neural network, a PP may comprise one or more neurons of the NN.

An output of a PP in an inference may be referred to an activation of the PP, and may, for example, correspond to the aggregation of respective activations of a plurality of units of which the PP is composed.

Similarly, an output of a unit or neuron of the ML predictor in an inference may be referred to an activation of the unit or neuron, respectively.

For determining the relevance score associated with the inference of the data structure 16, apparatus 10 may perform a reverse propagation 30. The reverse propagation starts at a first predetermined predictor portion 24, referred to as first PPP in the following. As already described before, one or more portions of units of the ML predictor may be regarded, or handled, as one portion of the ML predictor. In the illustrative example of FIG. 1b, the first PPP comprises two PPs of the ML predictor, namely two output portions 36. In other examples, the first PPP may comprise only one of the PPs 36, or further PPs.

For the reverse propagation, an initial relevance score is attributed to the first PPP 24, which is propagated in reverse direction 32, e.g. reverse with respect to a propagation direction of the data flow in an inference on a data structure, through the ML predictor 12.

The reverse propagation may, but does not necessarily start at the output of the ML predictor, but may start at any portion of the ML predictor.

The initial relevance value may be a predetermined value, e.g. 1. Alternatively, the initial relevance value may correspond to, or may be derived based on, the activation of the first PPP 24 in the inference, for which the reverse propagation is performed.

The apparatus 10 may perform the reverse propagation, for example, by successively determining respective relevance scores for upstream PPs of current PPs, for which current PPs respective relevance scores are already determined. In this context, the upstream direction corresponds to the reverse propagation direction 32, whereas the forward propagation direction of the inference may be referred to as downstream direction.

Accordingly, the reverse propagation may constitute propagation paths in upstream direction. It should be noted, that different propagation paths may overlap in one or more PPs and/or interconnections between PPs. For example, PP 14′ in FIG. 1b has two incoming propagation paths, contributing to the relevance score or PP 14′, and two outgoing propagation paths, which indicate respective shares of the relevance score of PP 14′ for two upstream PPs of PP14′.

According to examples, the apparatus reversely propagates the relevance score from the first PPP 24 to the data structure 16. The propagation paths may end, or point to portions of the data structure. E.g., in the illustration of FIG. 1b, portion 22 receives two propagation paths, and portions 22′, 22″ receive each one propagation path. In other words, the reverse propagation may map the initial relevance score onto one or more portions 22, 22′, 22″ of the data stream 16. It is noted that the portions 22 are not necessarily closed regions as illustrated in FIG. 1b, but may be composed of a plurality of portions, e.g. of arbitrary shape.

According to embodiments of the first aspect of the present invention, the apparatus filters the reverse propagation by weighting a first propagation path through the ML predictor, the first propagation path passing through a second predetermined predictor portion of the ML predictor, referred to as second PPP in the following, differently than a second propagation path through the ML predictor, the second propagation path circumventing the reverse propagation.

The second PPP may be different from the first PPP. For example, the second PPP may be positioned upstream in the ML predictor with respect to the first PPP.

For example, considering in FIG. 1b PP 14′ as the second PPP, propagation path 30₁ passes through the second PPP 14′, while propagation path 30₂ circumvents the second PPP 14′.

In examples, the apparatus may consider only propagation paths for the determination of upstream PPs of the second PPP, e.g. the portion 22 of the data structure, which pass through the second PPP. In other words, the weights for filtering the reverse propagation may be one of paths passing through the second PPP and zero for paths circumventing the second PPP.

For example, the CRP algorithm described in section 4.1 below may be an example of a filtered reverse propagation.

The reverse propagation is not necessarily performed until the input data structure 16, but may in alternative examples merely be performed until a PP of the ML predictor, which may be referred to as target PP. The target PP may be upstream with respect to the first PPP and/or the second PPP.

It is noted that embodiments of the first alternative of the first aspect and the second alternative of the first aspect may, in examples, merely differ in whether the reverse propagation is performed until the data structure (first alternative) or until a PP (second alternative). In this context it is noted that the data structure or portions thereof may also be regarded as PPs, at least with respect to the attributability of a relevance score. Accordingly, it is clear, that details described herein equivalently apply to the subject-matter of both claim groups.

In other words, apparatus 10 may perform the reverse propagation up to the data structure 16, or a portion thereof, or may alternatively perform the reverse propagation until a PP of the ML predictor, e.g. PP 26.

It is further noted, that the concept of the subject matter of the first aspect is applicable to the subject-matter of the second aspect and vice versa.

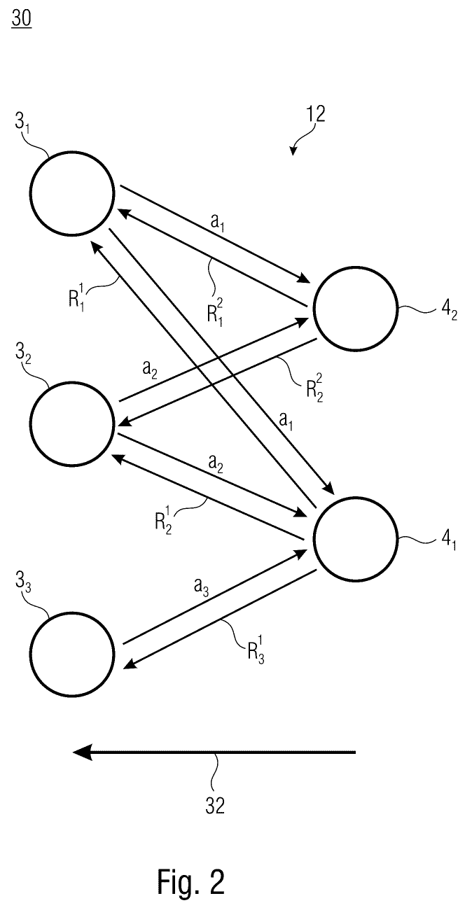

FIG. 2 illustrates an example of the reverse propagation 30. In the illustrative example of FIG. 2, neurons 3₁, 3₂, 3₃ of the ML predictor provide activations a₁, a₂, a₃ as inputs for neuron 4₁. Further, neuron 4₂ receives the activation of neurons 3₁, 3₂ as input. A neuron receiving an activation input from a certain neuron as an input may be referred to as downstream neuron of the certain neuron. Similarly, a neuron providing an activation as an input to a certain neuron may be referred to as an upstream neuron of the certain neuron.

Neuron 4₁ may be a current neuron in the reverse propagation, i.e. the neuron, the relevance score of which is currently to be reversely propagated. That is, the relevance score of neuron 4₁ is known, e.g. as it is, or belongs to, the first PPP 14′, or by reverse propagation from the first PPP 14′. The relevance score of neuron 4₁ may be distributed to the upstream neurons of the current neuron 4₁. To this end, respective upstream shares R¹ of the relevance score of the current neuron for the upstream neurons may be determined. The distribution may be performed so that fractions, with which the activation of the upstream portions contribute to an activation of neuron 4₁ in the reversely propagated inference, correspond to respective fractions of relevance shares R₁¹, R₂¹, R₃¹ determined for the upstream neurons of the current neuron 4₁. It is noted, that the relevance share is not necessarily determined for each of the upstream neurons, e.g., in examples, in which filtering of propagation paths is applied. Still, the relevance shares may be determined by distributing the relevance score of the current neuron to all upstream neurons of the current neuron.

The relevance score for an upstream neuron, e.g., neuron 3₂, may be determined by aggregating (e.g. adding or taking the maximum value, multiplication or any other measure of aggregation or pooling) incoming relevance shares from downstream neurons. For example, the relevance score of neuron 3₂ may be composed of the upstream relevance share R₂¹, and, if neuron 4₂ is part of a propagation path, that is, for example, has a non-zero relevance score and/or has received an upstream relevance share in previous propagation steps, further of an upstream relevance share R₂² from neuron 4².

In the case that the above-mentioned filtering of the reverse propagation is applied, the upstream relevance shares attributed to a neuron may be weighted differently. E.g., in the exemplary scenario in which neuron 4₂ is the second PPP, in the determination of the relevance score for neuron 3₂, relevance shares R₂¹ and R₂² may be weighted differently, as in this scenario, from the perspective of neuron 3₂, relevance share R₂¹ originates from a propagation path passing through the second PPP, whereas relevance share R₂² originates from a propagation path circumventing the second PPP. In examples, in which the filtering implies that merely propagation paths passing through the second PPP are considered, in the determination of the relevance score for neuron 3₂, share R₂² may be disregarded in this scenario. Accordingly, in examples, not necessarily all upstream relevance shares attributed to a neuron are considered in the determination of the relevance score for a neuron.

The same concept of reverse propagation may be applied to portions comprising multiple neurons. For example, grouping neurons 4₁, 4₂ into one portion, the reverse propagation of relevance scores may be performed equivalently as described above.

For example, in section 4.1 below, R_{i←j} may refer to an upstream relevance share, Rᵢ to a relevance score of a neuron or a portion, and aᵢ to an activation of a neuron.

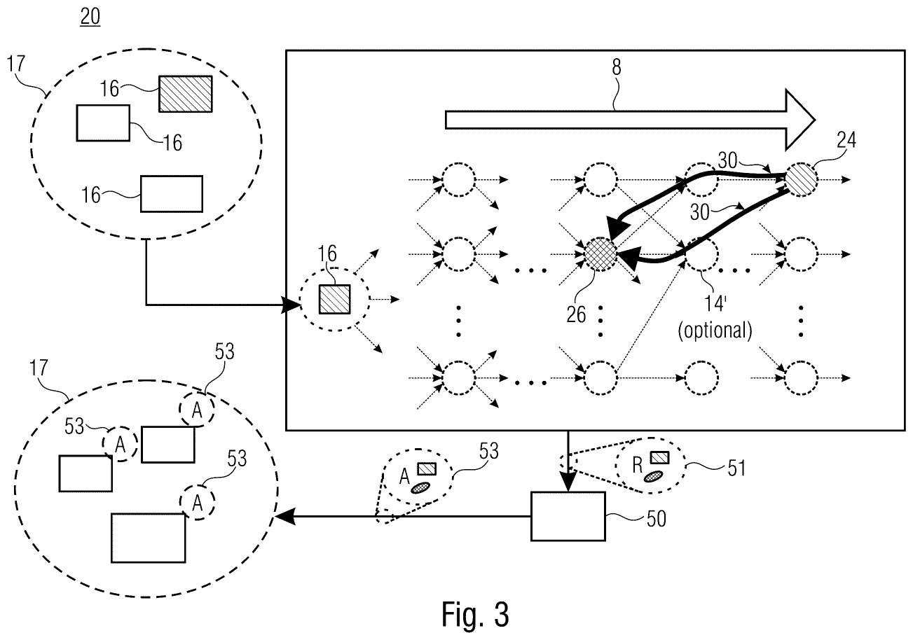

FIG. 3 illustrates an example of an apparatus 20. Apparatus 20 determines, for each data structure 16 of a set 17 of data structures, an affiliation score 53. The affiliation score 53 indicates an affiliation of the respective data structure 16 to a concept associated with, or encoded by, a PP 26 of a ML predictor 12. Apparatus 20 determines, e.g. by means of block 50, the affiliation score 53 for a data structure based on a relevance score 51 determined for the PP 26 with respect to an inference 8 performed by the ML predictor 12 on the data structure 16. The relevance score 51 indicates a contribution of the PP 26 to an activation of a first predetermined PP 24 of the ML predictor 12, which activation is associated with, e.g. occurs in, the inference 8 performed by the ML predictor on the data structure 16.

Apparatus 20 determines the relevance score 51 of the PP 26 by performing a reverse propagation 30 of an initial relevance score attributed to a first PPP 24 of the ML predictor.

The PP 26 may be located upstream in the ML predictor with respect to the first PPP.

The affiliation score 53 may, in examples, correspond to the relevance score 51 determined for the respective data structure. Alternatively, the affiliation score 53 may be determined based on the relevance score 51.

All details described before with respect to FIG. 1b and FIG. 2 may optionally apply equivalently to apparatus 20 of FIG. 3. It is noted, however, that apparatus 20 of FIG. 3 may, but does not necessarily apply a filtering in the reverse propagation 30.

For example, the details of one or more of the description of the ML predictor 12, portions and units thereof, the reverse propagations 30, the initial relevance score, the first PPP 24, a location thereof (e.g. the first PPP 24 may be an output of the ML predictor or may be an intermediate portion (not an output portion)) may optionally be applied to the apparatus 20 of FIG. 3.

In examples, apparatus 20 may further rank the data structures 16 of the set 17 according to their assigned relevance scores and/or apparatus 20 may select a subset of data structures 16 based on their assigned relevance scores. For example, the selected subset may be considered representative of a concept associated with the PP 26. That is, for example, a content represented by the selected and/or highest ranked data structures may be considered representative of content-related data structure properties which result in a certain contribution of the PP 26 to the activation of the first PPP 24. Accordingly, these content-related data structure properties may be considered to represent a concept of the PP 26.

In the following, embodiments of the present invention, and advantages thereof, along with application examples, are described in more detail.

It is noted, that details described in the following may be individually combined with the subject-matter of the claims. In particular, the methods described in section 4 are applicable independently from specific implementation details described in the following.

In particular, without loss of generality, due to the methods' properties being based on the decomposition of mapping functions, both the proposed Concept Relevance Propagation attribution approach (section 4.1), as well as consequently the Relevance Maximization approach (section 4.2) for selecting representative examples for (latent) model encodings/units can be applied to Non-neural-network machine learning predictors which can be formulated as directed (acyclic) graphs (DAG) of mappings, or can be transferred to such a form, via e.g. the process of Neuralization[47, 48, 49]. In other words, the techniques described in Section 4 below are applicable to machine learning predictors other than neural networks, given those predictors have been neuralized, or are described or describable as DAG.

According, what is disclosed in FIG. 1a, FIG. 1b and FIG. 2 is an embodiment of an apparatus 10 (e.g. for analyzing an inference performed by a machine learning (ML) predictor on a data structure), which is, according to the first alternative of the first aspect, configured for assigning a relevance score to a portion 22 of a data structure 16 (e.g. to a pixel of a digital image), the relevance score rating a relevance of the portion for an inference performed by a machine learning (ML) predictor 10 (e.g., an artificial neural network (NN)) on the data structure (e.g., the inference being the network output of applying the NN to the data structure) (e.g., the relevance score indicating a share with which propagation paths, which connect the portion with the first predetermined PP, contribute to an activation of the first predetermined PP, which activation is associated with the inference), wherein the apparatus is configured for determining the relevance score for the portion by performing a reverse propagation 30 of an initial relevance score, which is attributed to a first predetermined predictor portion (PP) 24 of the ML predictor, from the first predetermined PP through the ML predictor (or along propagation paths of the ML predictor) onto the portion of the data structure, and by filtering the reverse propagation by weighting a first propagation path 30₁ through the ML predictor, the first propagation path passing through a second predetermined PP 14′ (E.g., a set of one or more units or neurons; E.g., the second predetermined PP is upstream relative to the first predetermined PP with respect to a forward propagation direction (e.g., used for inference) of the ML predictor) of the ML predictor, differently than a second propagation path 30₂ through the ML predictor, the second propagation path circumventing (or not passing through) the second predetermined PP (e.g., the propagation paths connecting the portion with the first predetermined PP; e.g., the apparatus derives the relevance score by aggregating relevance values resulting from reversely propagating the initial relevance value along propagation paths connecting the first predetermined PP and the portion of the data structure).

Alternatively (second alternative of the first aspect), apparatus 10 may be configured for assigning a relevance score to a predictor portion PP (26) (e.g. a target PP) of the ML predictor 12 (e.g., an artificial neural network (NN)) for performing an inference on the data structure 16 (e.g., a inference on the data structure), the relevance score indicating a share with which propagation paths, which connect the PP 26 (e.g. the target PP) with a first predetermined PP 24 of the ML predictor, contribute to an activation of the first predetermined PP, which activation is associated with the inference performed by the ML predictor on the data structure. Apparatus 10 is in this case configured for determining the relevance score for the PP 26 by performing a reverse propagation 30 of an initial relevance score, which is attributed to the first predetermined PP, along the propagation paths, and for filtering the reverse propagation by weighting a first propagation path (30₁) through the ML predictor, the first propagation path passing through a second predetermined PP 14′ (e.g., a set of one or more units or neurons) of the ML predictor, differently than a second propagation path 30₂ through the ML predictor, the second propagation path circumventing (or not passing through) the second predetermined PP (e.g., the propagation paths connecting the (target) PP with the first predetermined PP; e.g., the apparatus derives the relevance score by aggregating relevance values resulting from reversely propagating the initial relevance value along propagation paths connecting the first predetermined PP and the (target) PP).

As already mentioned, in examples, the first and second alternatives may merely differ in that the reverse propagation is performed up to the portion 22 of the data structure, while in the second alternative, the propagation may be performed up to PP 26, which may be a portion of the predictor, or, as far as the data structure, or the interconnections of portions of the data structure with portions of the ML predictor, may be considered as portions of the ML predictor, up to a portion of the data structure as in the first alternative. Accordingly, the details described in the following may apply to both alternatives, as long as they comply with this difference.

According to an embodiment, apparatus 10 is configured for filtering the reverse propagation by selectively taking into account propagation paths 301 connecting the first predetermined PP 24 and the portion 22 of the data structure 16, which propagation paths pass through the second predetermined PP 14′ (and, e.g., disregarding propagation paths 302 circumventing, or not passing through, the second predetermined PP 14′; e.g. equation 7 of section 4, see Kronecker-Delta, e.g., representing weights 0 and 1 for circumventing and passing through paths, respectively).

According to an embodiment, the initial relevance score is one of a predetermined value (e.g. one), and an activation of the first predetermined PP 24, which activation is associated with the inference performed by the ML predictor 12 on the data structure 16.

According to an embodiment, see, e.g., FIG. 2, the ML predictor comprises neurons and neuron interconnections, (see, e.g., neurons 3 and 4 of FIG. 2, neuron 4₁ receives the activation of neurons 3₂, 3₃, i.e. neuron 4₁ is interconnected with neureons 3₂, 3₃) (e.g., the ML predictor 12 comprises a plurality of predictor units, which may also be referred to as nodes, or neurons. In examples, the ML predictor comprises or is composed of a neural network (NN). More general, for example, the ML predictor is representable as directed (acyclic) graph (DAG) of mappings, the mappings, for example, being performed by respective units) and wherein the apparatus is configured for performing the reverse propagation by determining a relevance score for a neuron 3₁ of the ML predictor based on (e.g., by aggregating, e.g. by summation) upstream relevance shares R₁¹, R₂² (e.g., R_{i←j} of section 4) from a set of downstream neurons (e.g., not necessarily all if, for instance, the filtering suppresses certain inter-neuron connections) (e.g., neurons 4₁, 4₂ in FIG. 1b) of the neuron 3₁ which, according to the ML predictor, are activation recipients of the neuron 3₁ (e.g., downstream neurons receive an activation of the neuron as an input when performing the inference; E.g., in the reverse propagation, the apparatus determines the relevance score for the neuron from the relevance scores of one or more downstream neurons (the set of downstream neurons); i.e., the reverse propagation may be performed in upstream direction. E.g. the downstream neurons are in downstream direction on respective propagation paths passing through the neuron) (E.g., an upstream relevance share of the neuron form a downstream neuron corresponds to a share of the relevance score of the downstream neuron, which is attributable to the activation of the neuron fed to the downstream neuron).

According to an embodiment, the apparatus 10 is configured for determining the upstream relevance share R₁¹, R₂² (which may, e.g., as described before, be regarded as a relevance score of a connection between two neurons) for each of the set of downstream neurons 4₁, 4₂ according to a fraction at which an activation a₁ of the neuron 3₁ in the inference on the data structure contributes to an activation of the respective downstream neuron 4₁, 4₂ in the inference.

For example, the apparatus may, in performing the reverse propagation 30, distribute a relevance score at a predetermined (e.g., current) neuron of the ML predictor onto upstream neurons of the predetermined neuron according to fractions, which correspond to further fractions at which activations of the predecessor neuron contribute to an activation of the predetermined neuron in the inference.

In addition or in alternative to the activation, the upstream relevance shares may be determined on the basis of one or more other measures. For example, a (modified) gradient backpropagation process, e.g., GradCam, may be used after the inference on the data structure to determine, for each of the set of downstream neurons 4₁, 4₂, a (modified) gradient value for each upstream neuron of the respective downstream neuron, and apparatus 10 may determine the upstream relevance shares R₁¹, R₂² based on the (modified) gradient values directed at the respective neuron 3₁.

In general, the apparatus 10 may also be configured for determining the upstream relevance share R₁¹ (which may, e.g., as described before, be regarded as a relevance score of a connection between two neurons) of a connection between a neuron 3₁ and a downstream neuron 4₁ of the neuron 3₁ according to a fraction between a weight/parameter/measure a1 connecting downstream neuron 4₁ to neuron 3₁ and a total (or any aggregation) of the weights/parameters/measures of all connections between downstream neuron 4₁ and any upstream neuron of the downstream neuron 4₁, e.g. neurons 3₁, 3₂, 3₃.

In examples, the apparatus 10 may determine the upstream relevance share R₁¹, R₂² (which may, e.g., as described before, be regarded as a relevance score of a connection between two neurons) based on a combination of one or more or all of the variants described above.

According to an embodiment, the second predetermined PP 14′ comprises one or more neurons of the ML predictor (e.g., the ML predictor comprises or is composed of a neural network (NN), or is representable as directed (acyclic) graph (DAG) of mappings, and comprises a plurality of predictor units, which may also be referred to as nodes, or neurons; E.g., the one or more neurons of the second predetermined PP may belonging to a certain channel and/or layer of the ML predictor or NN).

According to an embodiment, in performing an inference, the second predetermined PP 14′ is sensitive to a specific concept (or pattern), which is potentially present in the content of the data structures.

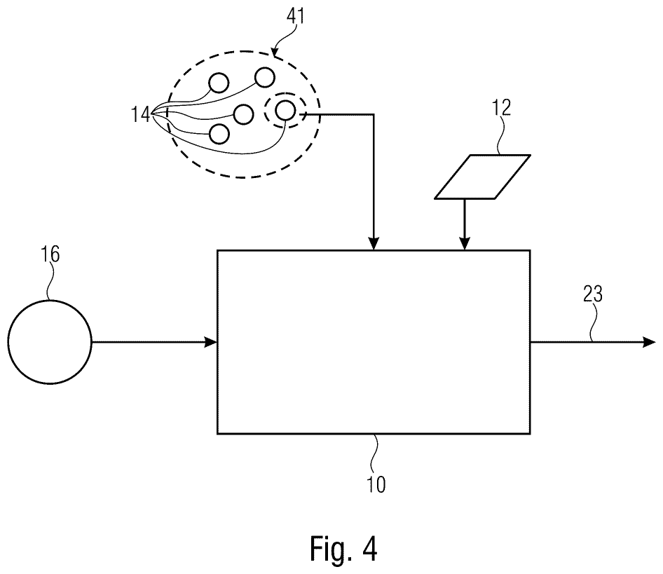

FIG. 4 illustrates an embodiment of apparatus 10 according to which the apparatus 10 is configured for performing a reverse propagation from the first predetermined PP 24 up to a set 41 of PPs 14 so as to obtain a PP relevance score 23 for each of the PPs. According to this embodiment, apparatus 10 is configured for determining the second predetermined PP 14′ based on the PP relevance scores for the set of PPs. For example, apparatus 10 performs, for each of the PPs 14 of the set 41, a reverse propagation from the first PPP 24 to the respective PP for determining the respective PP relevance score 23.

According to an embodiment, the apparatus 10 is configured for determining the PP relevance score 23 for each of the set of PPs by performing, in an unfiltered manner, a reverse propagation of the initial relevance score attributed to the first predetermined PP 24 from the first predetermined PP 24 through the ML predictor (or along propagation paths of the ML predictor) onto the respective PP 14.

According to an embodiment, the apparatus 10 is configured for obtaining the second predetermined PP 14′ from the set of PPs by one or more of (i) ranking the PPs of the set of PPs according to their PP relevance scores and using one out of one or more highest ranked PPs as the second predetermined PP 14′ and (ii) using an input received via a user interface for selecting the predetermined PP.

In the following, the description of what is disclosed in FIG. 1b and FIG. 2 is continued, details of FIGS. 3 and 4 may optionally be combined also with the following features.

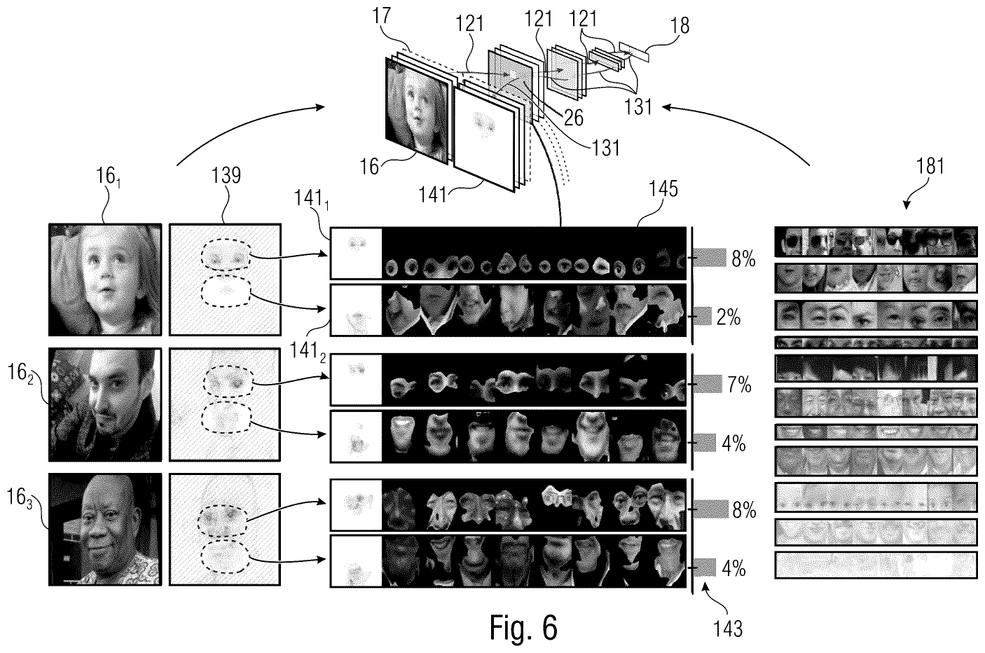

According to an embodiment, the apparatus 10 is configured for generating a relevance map (e.g., a heatmap, e.g. a conditional heatmap, such as heatmap 141 descibed with respect to FIGS. 6, 7d, 10), which indicates, for a plurality of portions of the data structure, respective relevance scores with respect to the inference performed on the data structure.

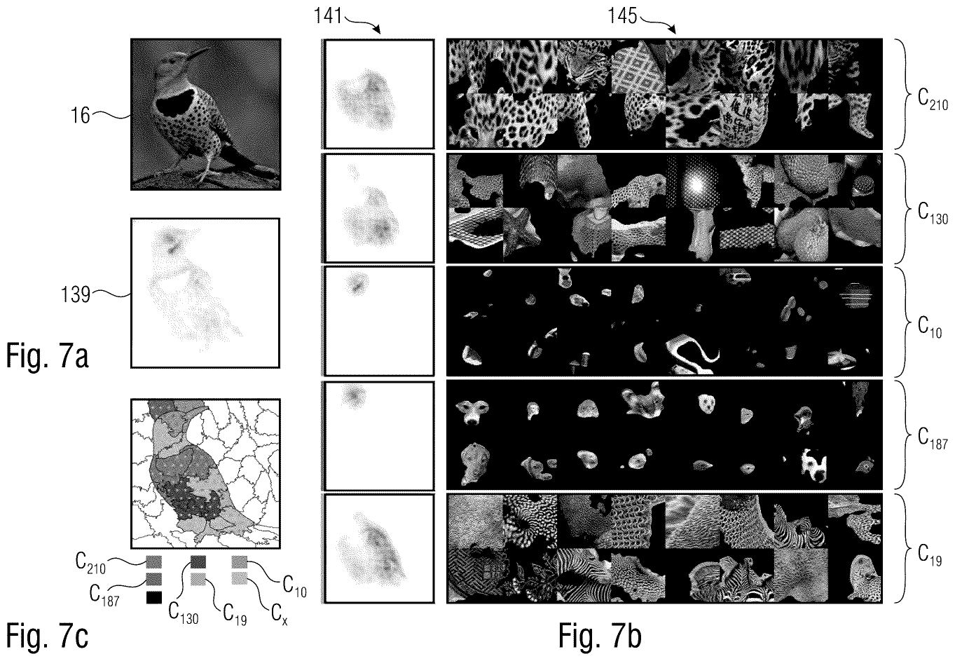

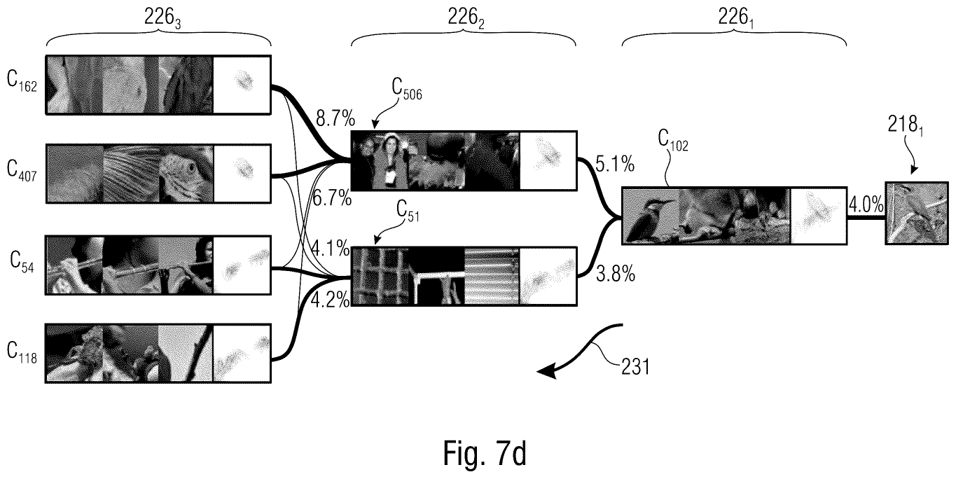

According to an embodiment, the apparatus 10 is configured for determining respective relevance scores for a plurality of portions of the data structure, and masking portions of the data structure depending on whether the respective relevance scores for the portions fulfill a condition (e.g. exceed a threshold) (or do not fulfill the condition). See, e.g., partial images 145 of FIG. 6 or FIG. 7b, which may be obtained by such a masking.

According to an embodiment, the apparatus 10 is configured for assigning respective relevance scores to a plurality of portions of the data structure by performing the reverse propagation from the first predetermined PP 24 to the data structure; and selecting a set of (one or more) portions of the data structure out of the plurality of portions of the data structure based on the respective relevance scores (e.g., by ranking the portions according to their relevance scores, and selecting one or more highest ranked portions; or by selecting portions, the relevance scores of which fulfil a predetermined criterion, e.g. exceed a predetermined threshold, see, e.g., partial images 145 desribed with respect to FIG. 6 or 7b). Optionally, apparatus 10 may present the set of portions of the data structure via a user interface, e.g. a display.

According to an embodiment, the apparatus 10 is configured for labelling the portion 22 (or, cf. second alternative, the PP 26) of the data structure as being affiliated to the second predetermined PP 14′, and/or as being associated with a concept represented by the second predetermined PP 14′.

According to an embodiment, the apparatus 10 is configured for performing the inference on the data structure 16 by means of the ML predictor 12.

According to an embodiment, the ML predictor comprises a neural network (NN) comprising a plurality of layers 13 (e.g. layers 13 of FIG. 1b. Note that layers 13 are optional in FIG. 1b), the plurality of layers comprising a convolutional layer, wherein the convolutional layer comprises a plurality of channels. In examples, the NN may be a convolutional NN, see, e.g., sections 1 to 4 below. In examples, the NN may comprise convolutional layers, and/or fully connected/dense layers, and/or other mapping functions the connections of which can be described via a directed graph structure.

For example, the convolutional layer comprises a plurality of output channels, e.g., a channel is configured for applying a filter (which may be specific to the channel, and may differ from the filter applied by a different channel) to a plurality of portions of input data of the channel (e.g., the input data comprises a plurality of features, a portion comprising a subset of the features), so as to determine, for each of the portions, one output feature of the channel. E.g., the filter may be a tensor. E.g., the filter may be spatially invariant or equal for each of the portions of the input data. E.g., the input data may be represented in one or more 2D arrays, or multi-dimensional arrays. E.g., the input data may comprise one or more channels, each comprising a data array (2D or multi-dimentional). A portion of the input data may comprise the data of a region within one or more channels of the input data, e.g., in case of multiple channels, data within collocated regions in the arrays of the multiple channels.

The filter may be composed of a convolutional kernel (of one or multiple dimensions, e.g. three dimension in case of the input data comprising multiple channels of 2D arrays), the kernel comprising a plurality of weights (e.g. weights wᵢⱼ of section 4). The channel may convolve the input data using the kernel. Each of the above-mentioned portions of the input data may be defined by one scan position of the kernel in performing the convolution. E.g., in the notation of section 4, aᵢ may represent a feature of the input data, the sum in equation 3 being over all features (or activations) of one portion of the input data, e.g. input data covered by the kernel at a specific scan position of the convolution.)

In other words, in the context of a convolutional layer, one of the above-mentioned neurons may be represented by one scan position of a convolution performed in the convolutional layer. The output of the neuron may be one feature or activation (e.g. one value), e.g. aⱼ in equation 4, which may be derived by aggregating the weighted input activations (the features of the portion of the input data, weighted using the weights of the kernel). The output of one neuron may be part of a feature map, or output channel, of one channel of the layer, which channel may be used, e.g. in conjunction with further channels of the layer, as an input of a further layer of the NN.

In view of the just described, the network portion, i.e., the predictor portion, may, for example, be one or multiple channels of a convolutional layer. Alternatively, the network portion may be a portion of a channel, e.g. one or more neurons, e.g. a portion of a channel representing a region within the channel.

It is noted that the above description may optionally apply to the embodiments of both alternatives of the first aspect and to embodiments of the second aspect, which may also relate to NNs with a convolutional layer.

According to an embodiment, the data structure 16 is a digital image, and the portion 22 comprises a region within the digital image, or comprises one or more samples (or pixels) of the digital image.

According to an embodiment, the apparatus 10 is configured for filtering the reverse propagation by weighting a first propagation path through the ML predictor, the first propagation path passing through each of a plurality of predetermined PPs, which includes the second predetermined PP, differently than a second propagation path through the ML predictor, the second propagation path circumventing (or not passing through) at least one of the plurality of predetermined PPs.

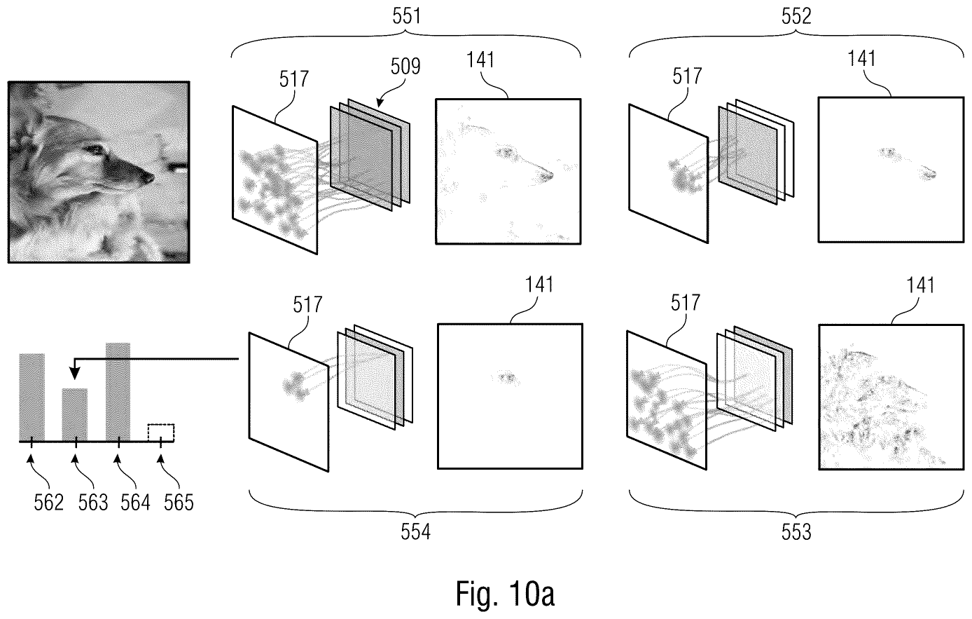

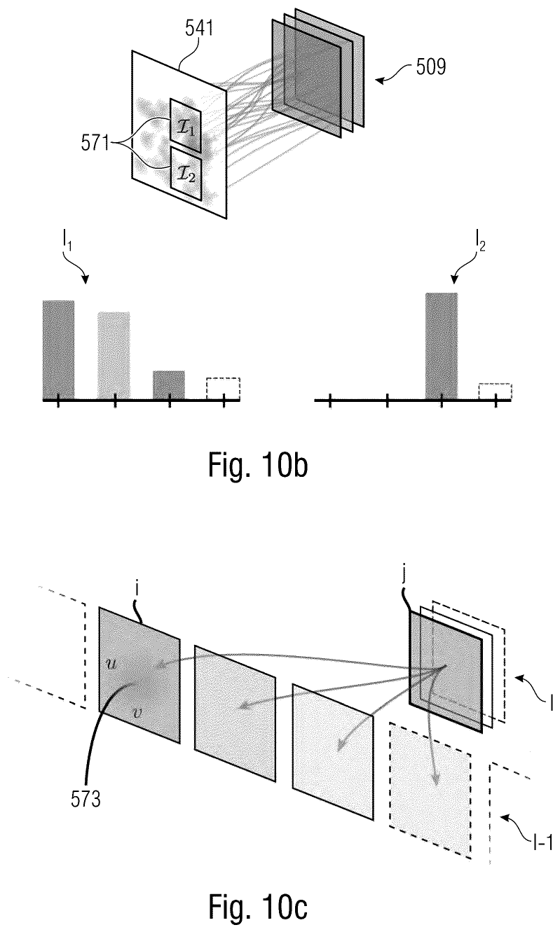

That is, for example, the reverse propagation may be filtered by (or conditioned on) multiple PPs, such allowing to analyzes sub-concepts of a concept. E.g., by filtering the reverse propagation using a predetermined PP, which is upstream of the second PPP 14′, the second PPP may be analyzed with respect to sub-concepts contributing to a concept represented by the second PPP, see FIG. 10d for example.

According to an embodiment, the first predetermined PP 24 represents (or corresponds to) a predictor output of the ML predictor (e.g., the predictor output is associated with one out of a set of one or more inference results of the inference, which inference result may be, but is not necessarily, a “highest rated” inference result, e.g., in case of a classifying ML predictor, the first predetermined PP 24 may correspond to one or more classes, not necessarily the class having attributed the highest confidence), or an intermediate predictor portion (not being an output of the ML predictor).

According to an embodiment, the data structure is, or is a combination of,
a picture comprising a plurality of pixels, wherein the portion of the data structure corresponds to one or more of the pixels or subpixels of the picture, and/or
a video, wherein the portion of the data structure corresponds to one or more pixels or subpixels of pictures of the video, pictures of the video or picture sequences of the video, and/or
an audio signal, wherein the portion of the data structure corresponds to one or more audio samples of the audio signal, and/or
a feature map of local features or a transform locally or globally extracted from a picture, video or audio signal, wherein the portion of the data structure corresponds to local features, and/or
a text, wherein the portion of the data structure corresponds to words, sentences or paragraphs of the text, or tokens extracted from the text (E.g., large language models may receive tokenized text input) and/or
a graph, such as a social network relations graph or any relational graph or semantic graph, wherein the portion of the data structure corresponds to nodes or edges or sets of nodes or a set of edges or subgraphs (For example, the herein disclosed method may be used to capture “activities” from present connections. For example, in the case that the model can detect vehicles and objects. While the model may separately detect mounds of sand, trucks and excavators, a simultaneous appearance might prompt the model to recognize the activity “digging and loading sand on a construction site”. With CRP, such relationships may be discovered).

According to an embodiment, the apparatus 10 is configured for determining respective relevance scores of the portion 22 of the data structure with respect to a plurality of first predetermined PPs (e.g., assigning respective relevance scores to the portion, the respective relevance scores indicating respective shares with which propagation paths, which connect the portion with the first predetermined PPs, contribute to an activation of the first predetermined PPs in the inference) by performing respective reverse propagations of respective initial relevance scores attributed to the first predetermined PPs (e.g., the plurality of first predetermined PPs comprises the first predetermined PP). The apparatus 10 may rank the first predetermined PPs according to the relevance scores determined for the portion of the data structure with respect to the first predetermined PPs and/or the apparatus 10 may select one or more first predetermined PPs out of the plurality of predetermined PPs based on the relevance scores determined for the portion of the data structure with respect to the first predetermined PPs.

Alternatively, cf. the second alternative of the first aspect, the apparatus 10 may perform the determination of the respective relevance scores for PP 26 rather than for portion 22. That is, apparatus 10 may be configured for determining respective relevance scores of the PP 26 with respect to a plurality of first predetermined PPs by performing respective reverse propagations of respective initial relevance scores attributed to the first predetermined PPs. The apparatus may rank the first predetermined PPs according to the relevance scores determined for the PP 26 with respect to the first predetermined PPs, and/or select one or more first predetermined PPs out of the plurality of predetermined PPs based on the relevance scores determined for the PP 26 with respect to the first predetermined PPs.

For example, the first predetermined PPs are output portions of the ML predictor, e.g. classes of a classifying PP. For example, the ranking/selection may be indicative of first predetermined PPs, for which a concept associated with the second predetermined PP is relevant (i.e., e.g., contribute to an activation).

According to an embodiment, the apparatus 10 is configured for pruning the ML predictor in dependence on the relevance score.

According to an embodiment, the apparatus 10 is configured for performing the inference for the data structure, and assigning the relevance score to the portion 22 (or the PP 26 in case of the second aspect). If the relevance score fulfils a predetermined criterion (e.g., exceeds or not exceeds a predetermined threshold), apparatus 10 may perform a further inference for the data structure, wherein the apparatus is configured for deactivating (or altering/manipulating, e.g., deactivation may be performed as pruning in the sense of a bit blunt. Alternatively, the model internal substructures may be altered in different ways, such as boosting or reducing activation strength of particular concept encodings in order to alter the model behavior.) the second predetermined PP in performing the further inference (e.g., disregarding an activation of the second predetermined PP in the inference). Optionally, the apparatus 10 may compare an inference result of the inference with a further inference result of the further inference, so as to obtain a confidence score on the inference result.

Now reverting to the embodiments of the second aspect described with respect to FIG. 3, what FIG. 3 describes is an embodiment of an apparatus 20 (e.g. for analyzing an inference behavior of a machine learning (ML) predictor on a data structure), configured for determining, for each out of a set 17 of data structures 16, an affiliation score 53 (or relevance score) with respect to a concept associated with a predictor portion (PP) 26 (e.g. a target PP, e.g. a PP under investigation) of a machine learning (ML) predictor 12 (wherein the concept represents a type of content, to which the predetermined network portion is sensitive, or in response to which the predetermined network portion contributes to a predetermined inference result. or to an activation of a first predetermined PP in an inference of the data structure. E.g., the affiliation score rates, to which extent a content represented in the respective data structure correlates with a concept associated with a predetermined predictor portion of an ML predictor or artificial neural network (NN)).

Apparatus 20 determines the affiliation score 53 of one of the data structures 16 by determining a relevance score 51 for the PP 26 with respect to an inference 8 performed by the ML predictor 12 on the respective data structure 16, wherein the relevance score indicates a contribution of the PP 26 to an activation of a first predetermined PP 24 of the ML predictor, which activation is associated with the inference 8 performed by the ML predictor on the data structure. The apparatus is configured for determining the relevance score by performing a reverse propagation of an initial relevance score (which is attributed to the first predetermined PP) from the first predetermined PP to the PP (the target PP), e.g., the reverse propagation as already described with respect to FIG. 2.

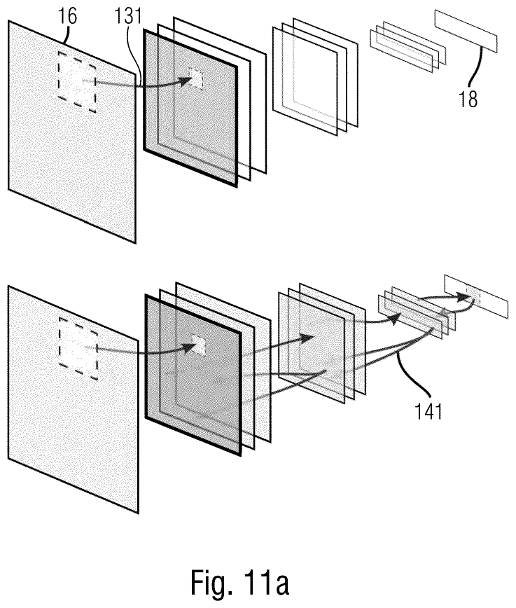

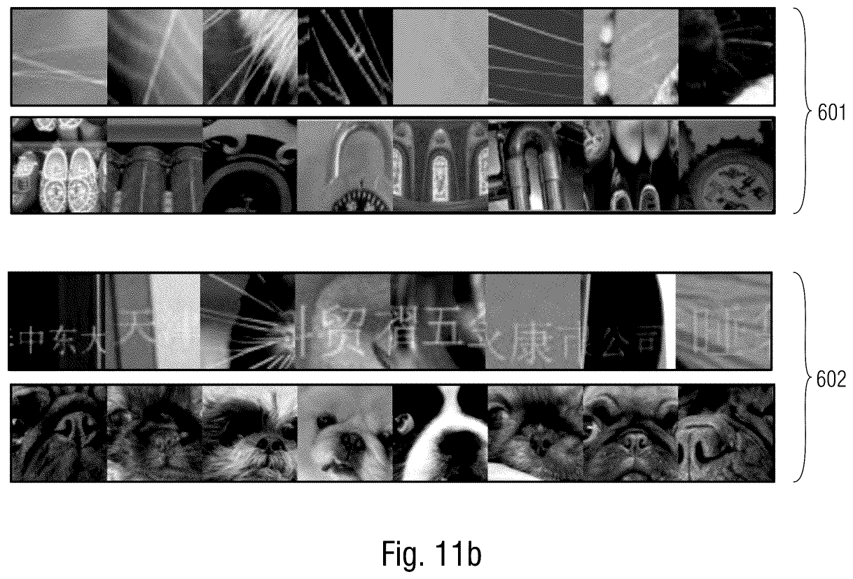

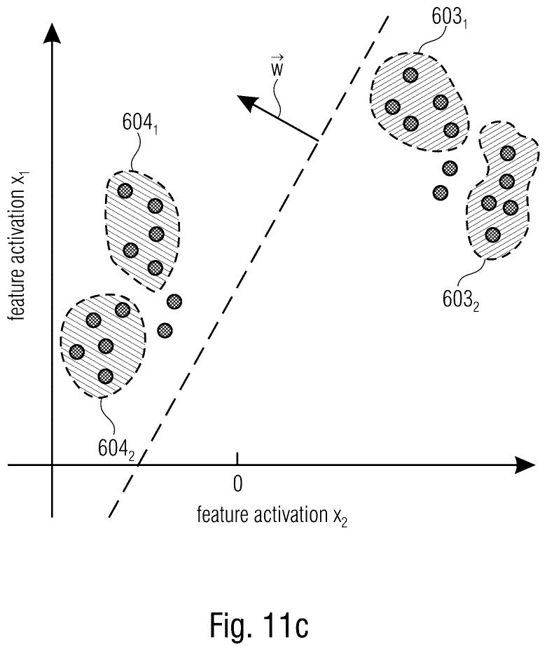

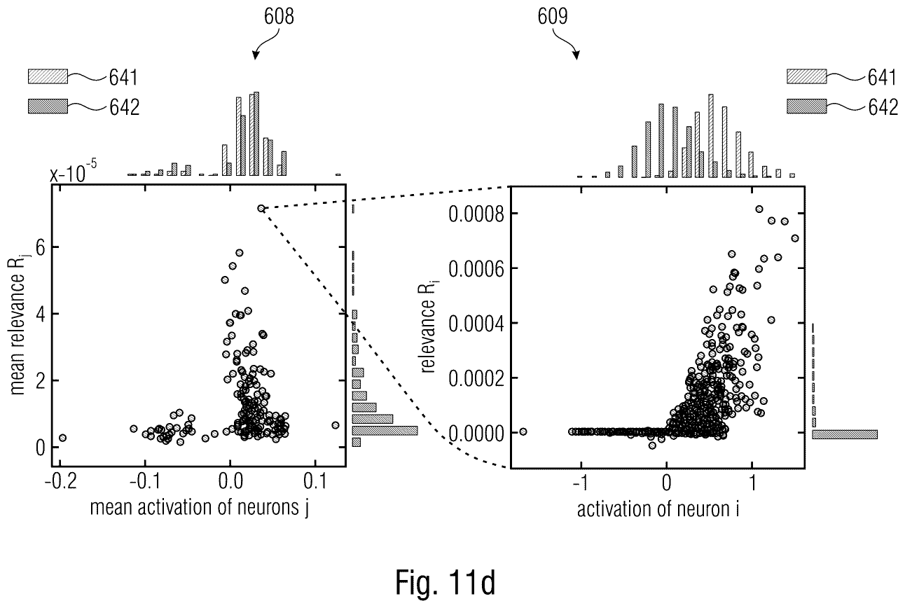

Further details and advantages of apparatus 20 are described below in section B, 4.2.2, and in particular with respect to FIG. 11.

According to an embodiment, (see, e.g., FIG. 4, the description thereof may optionally also apply to apparatus 20) apparatus 20 is configured for obtaining the PP 26 (the target PP) of the ML predictor out of a set 41 of PPs 14 of the ML predictor 12 based on respective relevance scores 23 for the PPs of the set 41 with respect to inferences performed on the set 17 of data structures 16, e.g., as described with respect to FIG. 4.

For example, the apparatus 20 performs a reverse propagation of an initial relevance score from the first predetermined PP, or from an output portion of the ML predictor, through the ML predictor, passing, in the reverse propagation, a plurality of PPs 14, thereby assigning them respective relevance scores. E.g., the apparatus 20 may reversely propagate the result of an inference of performed on one of the data structures.

Accordingly, the relevance scores assigned to the PPs may indicate, which of the PPs are particularly relevant to the output of the inference. A PP having a particularly high relevance score may, e.g., encode a concept, which is relevant for the output. Apparatus 20 may select the target PP 26 out of the set 41 of PPs, e.g., by selecting a PP having assigned a relevance score, which fulfils a predetermined condition such as exceeding a threshold.

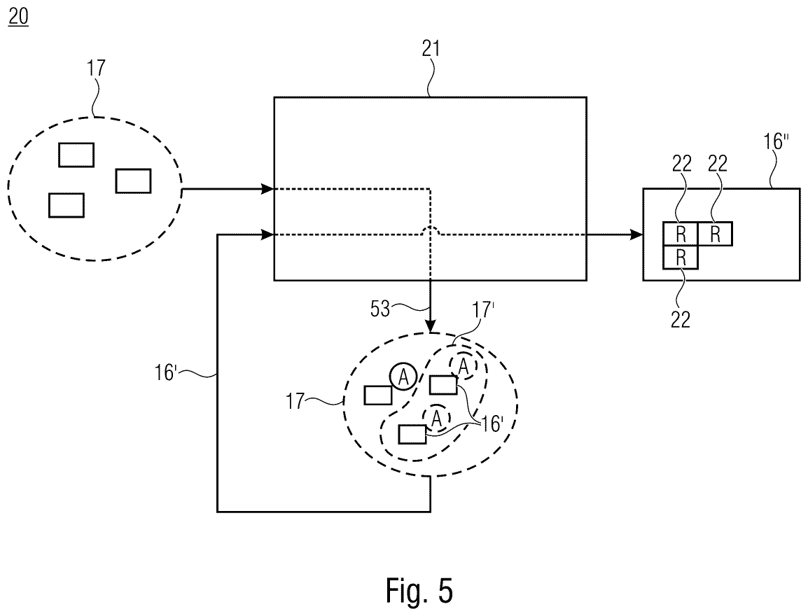

FIG. 5 illustrates a further embodiment of apparatus 20, according to which apparatus 20 is configured for selecting a subset of data structures out of the set of data structures based on the affiliation scores determined for the data structures.

For example, apparatus 20 may assign a data structure to the subset, if the assigned affiliation score fulfils a predetermined criterion, e.g. exceeds a threshold. Accordingly, the subset may be a collection of data structures, which provoke a high relevance of the PP. Accordingly, the subset may be representative of a concept of the PP 26.

According to an embodiment, apparatus 20 is configured for selecting the subset of data structures by comparing the affiliation scores of the data structures to a threshold, or ranking the data structures according to their affiliation scores, and selecting, out of the set of data structures, a predetermined number of data structures having the highest ranked affiliation scores.

According to an embodiment, apparatus 20 is configured for presenting the selected subset of data structures, or respective portions thereof, at a user interface (e.g. a display).

According to an embodiment, see FIG. 3, the PP 26 (the target PP) is associated with a portion of the respective data structure (e.g., the PP may correspond to one or more interconnections of the ML predictor; in this respect, also an interconnection from a portion of the data structure to an input portion or input unit/neuron may be regarded as PP; accordingly, the apparatus may determine a relevance score for a portion of the data structure, e.g. as described with respect to the first alternative of the first aspect, wherein, the portion of the data structure may be understood as a PP of the ML predictor), and the apparatus 20 is configured for, for each of the selected subset 17′ of data structures, assigning respective relevance scores to a plurality portions 22 of the respective data structure 16′ by performing the reverse propagation from the first predetermined PP 24 to the PPs associated with the portions of the data structure. Apparatus 20 may further be configured for selecting a set of (one or more) portions of the respective data structure out of the plurality of portions of the respective data structure based on the respective relevance scores (e.g., by ranking the portions according to their relevance scores, and selecting one or more highest ranked portions; or by selecting portions, the relevance scores of which fulfil a predetermined criterion, e.g. exceed a predetermined threshold). Optionally, apparatus 20 may present the set of portions of the respective data structure via a user interface, e.g. a display. By selecting the set of portion, apparatus 20 may e.g., generate a masked image in cases in which the data structure is an image, e.g. as illustrated in FIG. 6, 7b.

For example, selecting the set of portions may localize portions of the data structure affiliated with the first predetermined PP. In other words, by determining the selected subset of data structures, the apparatus my identify data structures out of the set of data structures, which are affiliated with, or represent a concept of, the first predetermined PP.

In the following, the description of what is disclosed in FIG. 3 is continued, details of FIG. 5 may optionally be combined also with the following features.

For example, in the reverse propagation for the PPs, a filter may be applied, e.g. as described below, or as described with respect to the first aspect. In this case, the relevance scores assigned to the portions may further indicate an affiliation of the portions to concepts associated with the “filtering” PP, i.e. the second predetermined PP. Accordingly, by applying the filter, the concept of the first predetermined PP may be resolved in a finer granularity, or, in other words, may allow the identification of a sub-concept of the concept of the first predetremined PP, the sub-concept being associated with the second predetremined PP. The selected portions may be representative of this sub-concept, and may thus facilitate to reveal a semantic meaning of the sub-concept.

According to an embodiment, apparatus 20 is configured for, for each of the selected subset of data structures (e.g. the data structure being part of the subset indicates that the PP, to which the relevance score is assigned, is representative of a concept of the first predetermined PP), labelling the PP (e.g., the PP (the target PP) is associated to or represents a portion of the respective data structure, e.g., the PP may correspond to one or more interconnections of the ML predictor; in this respect, also an interconnection from a portion of the data structure to an input portion or input unit/neuron may be regarded as PP; accordingly, the apparatus may determine a relevance score for a portion of the data structure, e.g. as defined by claim group A, wherein, the portion of the data structure may be understood as a PP of the ML predictor) as being affiliated to the first predetermined PP, and/or as being associated with a concept represented by the first predetermined PP.

According to an embodiment, apparatus 20 is configured for filtering the reverse propagation by weighting a first propagation path 30₁ through the ML predictor, the first propagation path passing through a second predetermined PP 14′ of the ML predictor, differently than a second propagation path 30₂ through the ML predictor, the second propagation path circumventing the second predetermined PP. For each of the selected subset of data structures (e.g. the data structure being part of the subset indicates that the PP, to which the relevance score is assigned, is representative of a concept of the first predetermined PP), apparatus 20 may label the PP (e.g., the PP (the target PP) is associated to or represents a portion of the respective data structure, e.g., the PP may correspond to one or more interconnections of the ML predictor; in this respect, also an interconnection from a portion of the data structure to an input portion or input unit/neuron may be regarded as PP; accordingly, the apparatus may determine a relevance score for a portion of the data structure, e.g. as described with respect to apparatus 10 of FIG. 1a, FIG. 1b, wherein, the portion of the data structure may be understood as a PP of the ML predictor) as being affiliated to the first predetermined PP 24, and/or as being associated with a concept represented by the first predetermined PP 24.

According to an embodiment, apparatus 20 is configured for determining, for one of the selected data structures, an activation of the PP (the target PP) with respect to an inference on the data structure (by performing the inference using the ML predictor), and performing a reverse propagation of an initial relevance score derived from the activation of the PP, from the PP onto a further PP of the ML predictor. In other words, the PP may serve as the first predetermined PP 24 in a determination of a relevance score as described with respect to apparatus 10 before. Accordingly, the PP may be used as the first predetermined PP 24 of FIG. 1b, and the further PP may be regarded as target PP 26 of FIG. 1b, e.g. to apply a further filter.

According to an embodiment, apparatus 20 is configured for filtering the reverse propagation by weighting a first propagation path through the ML predictor, the first propagation path passing through a second predetermined PP (e.g., a set of one or more neurons) of the ML predictor, differently than a second propagation path through the ML predictor, the second propagation path circumventing (or not passing through) the second predetermined PP (e.g., the propagation paths connecting the predetermined network portion with the network output; e.g., the apparatus derives the relevance score by aggregating relevance values resulting from reversely propagating the initial relevance value along propagation paths connecting the network output and the predetermined network portion).

Details described with respect to filtering the reverse propagation, and the second predetermined PP, described with respect to the first aspect, i.e. apparatus 10 of FIGS. 1a, 1b, 2 may equivalently applied to apparatus 20.

The described apparatuses may also serve as a description of respective methods in a sense that further embodiments provide methods, which are defined by comprising, as steps of the methods, the steps performed by the described apparatuses.

### SECTION B—FURTHER DETAILS AND EMBODIMENTS

### 1. Introduction

Considerable advances have been made in the field of Machine Learning (ML), with especially Deep Neural Networks (DNNs) [19] achieving impressive performances on a multitude of domains [10, 38, 14]. However, the reasoning of these highly complex and non-linear DNNs is generally not obvious [33, 35], and as such, their decisions may be (and often are) biased towards unintended or undesired features [41, 18, 37, 2]. This in turn hampers the transferability of ML models to many application domains of interest, e.g., due to the risks involved in high-stakes decision making [33], or the requirements set in governmental regulatory frameworks [12] and guidelines brought forward [9].

In order to alleviate the “black box” problem and gain insights into the model and its predictions, the field of explainable Artificial Intelligence (XAI) has recently emerged. In fact, multitudes of XAI methods have been developed that are able to provide explanations of a model's decision while approaching the subject from different angles, e.g., based on gradients [25, 42], as modified backpropagation processes [4, 40, 39, 27], by probing the model's reaction to changes in the input [46, 32] or visualizing stimuli specific neurons react strongly to [11, 29]. The field can roughly be divided into local XAI and global XAI. Methods from local XAI commonly compute attribution maps in input space highlighting input regions or features, which carry some form of importance to the individual prediction process (i.e., with respect to a specific sample).

However, the visualization of important input regions is often of only limited informative value on its own as it does not tell us what features in particular the model has recognized in those regions, as FIG. 6 illustrates. Furthermore, attribution maps can be understood as a superposition of many different model-internal decision sub-processes (e.g., see [16]), working through various transformations of the same input features and culminating to the final prediction. Many intricacies are lost with local explanation techniques producing only a singular attribution map in the input space per prediction outcome. The result might be unclear, imprecise or even ambiguous explanations.

FIG. 6 illustrates a comparison between local XAI, global XAI, and an embodiment according to the present invention, which may be referred to as “glocal XAI”, in the exemplary scenario of image classification. FIG. 6 illustrates a method, in which, for example, an ML predictor is applied to an input 16, e.g., an image, which may be part of a datastet 17. The ML predictor may classify the input by mapping the input 16 to an output 18, the output 18 comprising a plurality of classes, to which the ML predictor may assign scores or probabilities. In processing the input, the ML predictor may, e.g., proces the input step by step, e.g. using a network of interconnected units, e.g., neurons, which are interconnected, so that the output of a unit is input to a subsequent unit. E.g., the units may be arranged in layers, the output of units of one layer being provided as input to a subsequent layer. The output of a unit may be referred to as activation 121 of that unit. Accordingly, the activations 121 may be propagated downstream from the input to the output. This way, each class of the output 18 may be attributed an attribution (e.g. score or probability). For analyzing, which part of the input is relevant for attribution attributed to a certain class, this attribution may be propagated backwards, i.e. upstream, as indicated by arrows 131 in FIG. 6, e.g., as described below (cf. LRP, CRP).

According to local XAI, for example, the attribution of one of the classes of output 18 may be backpropagated (or reversely propagated) through the entire ML predictor to the input 16 to obtain a heatmap 139, which indicates, to which extent individual parts or pixels of the input contribute to the attribution of the respective class. Accordingly, the heatmap 139 may indicate, where the model is looking at. Global XAI, on the other hand, may use a feature visualization, thereby answering the question, what features exist. To this end, a set 181 of categorized samples may be input to the ML predictor to check, e.g., the activation of a specific portion or unit of the ML predictor when processing samples of a specific category. That way, a concept represented by a category may be attributed to a specific portion or unit of the ML predictor.

According to embodiments of the present invention, an attribution attributed to a portion or a unit of the ML predictor (e.g. a class of the output 18 or a portion to which a specific concept is assigned, e.g. by measuring activations of categorized samples as described with respect to global XAI, or a portion to which a particularly high attribution is attributed in backpropagating the attribution of a class) may be backpropagated to the input 16 (or only up to a further portion of the ML predictor located upstream from the portion serving as origin) by filtering the backpropagation in a sense that only propagation paths through a certain portion of the ML predictor are considered or in a sense that propagation paths passing throug different portions of the ML predictor are weighted differently. E.g., as indicated in FIG. 6, only paths through portion 26 may be considered. In other words, the attribution flow may be conditioned, leading to a conditional heatmap 141.

In FIG. 6, three input images 16₁, 16₂, 16₃ assigned to different classes, namely classes, “age 3-7 years”, “age 25-32 years”, and “age 60+ years” are shown along with respective heatmaps 139. The heatmaps 139 visualize, which parts of the input images were most relevant for the decision to assign the images to their respective classes. Using conditional attribution flows, “concepts”, which played a role in the decision process, may be identified. E.g., for image 16₁, a first conditional heatmap 141₁ is obtained by conditioning the reverse attribution flow on a first portion of the ML predictor. Performing same process on further images assigned to the same class yields a set 145 of partial images, which represent a concept which may be assigned to the first portion of the ML predictor. E.g., in FIG. 6, the concept of the first portion resuliting in heatmap 141₁ may be labeled “big, round eyes”. E.g., for image 16₁, a second conditional heatmap 141₂ may be obtained by conditioning the reverse attribution flow on a second portion of the ML predictor, which may be labeled “smooth, chubby cheeks”, For the class of image 16₂, concepts labeled “eyes with strong eye brows” and “smile, beared chin” may be found, for the class of image 16₂, concepts labeled “wrinkled face with strong nose” and “stubby, chubby chin” may be found. Furthermore, a relevance score 143 may be assigned to each of the concepts, indicating the relevance of that concept to the decision. E.g., the relevance score may be obtained based on reverse propagated attributions.

As it is illustrated in FIG. 6, glocal XAI can tell which features exist and how they are used for predictions by unifying local and global XAI. (Left): Local explanations visualize which input pixels are relevant for the prediction. Here, the model focuses on the eye region for all three predictions. However, what features in particular the model has recognized in those regions remains open for interpretation by the user. (Right): By finding reference images that maximally represent particular (groups of) neurons, global XAI methods give insight into the concepts generally encoded by the model. However, global methods alone do not inform which concepts are recognized, used and combined by the model in per-sample inference. (Center): Glocal XAI can identify the relevant neurons for a particular prediction (property of local XAI) and then visualize the concepts these neurons encode (property of global XAI). Further, by using concept-conditional explanations as a filter mask, the concepts' defining parts can be highlighted in the reference images, which largely increases interpretability and clarity. Here, the topmost sample has been predicted into age group (3-7) due to the sample's large irides and round eyes, while the middle sample is predicted as (25-32), as more of the sclera is visible and eyebrows are more apparent. For the bottom sample, the model has predicted class (60+) based on its recognition of heavy wrinkles around the eyes and on the eyelids, and pronounced tear sacs next to a large knobby nose.

Assuming for example an image classification setting and an attribution map computed for a specific prediction, it might be clear where (in terms of pixels) important information can be found, but not what this information is, i.e., what characteristics of the raw input features the model has extracted and used during inference, or whether this information is a singular characteristic or an overlapping plurality thereof. This introduces many degrees of freedom to the interpretation of attribution maps generated by local XAI, rendering a precise understanding of the models' internal reasoning a difficult task.

Global XAI, on the other hand, attempts to address the very issue of understanding the what question, i.e., which features or concepts have been learned by a model or play an important role in a model's reasoning in general. Some approaches from this category synthesize example data in order to reveal the concept a particular neuron activates for [11, 43, 21, 26, 29], but do not inform which concept is in use in a specific classification or how it can be linked to a specific output. From these approaches, we can at most obtain a global understanding of all possible features the model can use, but how these features interact with each other given some specific data sample and how the model infers a decision remains hidden. Other branches of global XAI propose methods, e.g., to test a model's sensitivity to a priori known, expected or pre-categorized stimuli [15, 31, 5, 6]. These approaches require labeled data, thus limiting, and standing in contrast to, the exploratory potential of local XAI.

Some recent works have begun to bridge the gap between local and global XAI by, for example, drawing weight-based graphs that show how features interact in a global, yet class-specific scale, but without the capability to deliver explanations for individual data samples [13, 20]. Others plead for creating inherently explainable models in the hope of

replacing black box models [33]. These methods, however, either require specialized architectures, data and labels, or training regimes (or a combination thereof) [7, 8] and do not support the still widely used off-the-mill end-to-end trained DNN models with their extended explanation capabilities.

Embodiments of the present invention connect lines of local and global XAI research by introducing Concept Relevance Propagation (CRP), a next-generation XAI technique that explains individual predictions in terms of localized and human-understandable concepts. Other than the related state-of-the-art, CRP answers both the “where” and “what” questions, thereby providing deep insights into the model's reasoning process. As a post-hoc XAI method, CRP can be applied to (almost) any ML model with no extra requirements on the data, model or training process. As demonstrated on multiple datasets, model architectures and application domains, CRP-based analyses according to the present invention may allow one to (1) gain insights into the representation and composition of concepts in the model as well as quantitatively investigate their role in prediction, (2) identify and counteract Clever Hans filters [18] focusing on spurious correlations in the data, and (3) analyze whole concept subspaces and their contributions to fine-grained decision making. Similar to Activation Maximization [28], Embodiments according to a further aspect of the invention make use of the Relevance Maximization (RelMax) approach, which may use CRP in order to search for the most relevant samples in the training dataset, and show its advantages when “explaining by example”. In summary, by lifting XAI to the concept level, CRP opens up a new way to analyze, debug and interact with a ML model, which can be particularly beneficial for safety-critical applications and ML-supported investigations in the sciences.

Beginning with Section 2.1, we present approaches to study the role of learned concepts in individual predictions using our glocal CRP approach. The understanding of hidden features and their function then allows to interact with the model and to test its robustness against feature ablation in Section 2.2. In Section 2.3, we study concept subspaces in order to identify (dis)similarities and roles of concepts in fine-grained decision making.

### 2.1 Understanding Concept Composition Leading to Prediction

Attribution maps, e.g. the heatmaps 139 of FIG. 6, provide only partial insights into the decision making process as they only show where the model is focusing on and not which concepts are actually being used. FIG. 7, including FIGS. 7a-d, illustrates an example of a method for investigating or understanding concepts and concept composition with CRP according to an embodiment. FIG. 7a shows an attribution map computed for the prediction “Northern Flicker”. The attribution map indicates that various body parts of the bird are relevant for the prediction. In this case, the bird's head—in particular the black eye and red stripe—has been identified as the most relevant part of the image. However, it remains unclear from the explanation whether the color or the shape (or both) of the eye and stripe were the decisive features for the model to arrive at its prediction, and how much these body parts contribute, e.g., compared to the bird's feathers. Furthermore, attribution maps almost always point to the head or the upper body of a bird, irrespective of the bird explained. Thus, the non-trivial task of interpreting what particular feature of the bird (e.g., color, texture, body part shape or relative position of the body parts) actually led to the decision is put onto the human user, which can result in false conclusions.

By conditioning the explanation on relevant hidden-layer channels via CRP, embodiments of the invention can assist in concept understanding and overcome the interpretation gap. FIG. 7b shows an exemplary result of a CRP analysis. The conditional heatmaps 141 help to localize regions in input space for each relevant concept, and at the same time reveal what the model has picked up in those regions by providing masked reference samples 145 (i.e., explaining by example). In FIG. 7b, five relevant channels are analyzed with respect to the concepts, which they represent, namely channels C₂₁₀, C₁₃₀, C₁₀, C₁₈₇, C₁₉, wherein the term “channel” refers to a portion of the ML predictor, e.g. one or more neurons. Here, the concepts we identified (based on a subjective understanding of the representative examples) as “red spot” for C₁₀ and “black eyes” for C₁₈₇ can be assigned to the head of the Northern Flicker bird. These concepts play a crucial role in the classification of the bird, although, e.g., the “black eyes” concept naturally also occurs in images of cats and dogs. Furthermore, both “dots” concepts affecting the prediction, i.e. concept “dots ˜8 px on beige color” assigned to channel C₂₁₀ and concept “dots ˜3 px” assigned to channel C₁₃₀, can be assigned to the bird's torso and the “elongated dots and stripes” concept assigned to channel C₁₉ to the bird's wings. Note that CRP also allows to quantitatively determine the individual contribution of each concept to the final classification decision by summation of the conditional relevance scores (see Section 4.1). For the example, the relevances of channels C₂₁₀, C₁₃₀, C₁₀, C₁₈₇, C₁₉ to the decision in FIG. 7b are 2.4%, 2.1%, 1.9%, 1.4%, and 1.4%, respectively. This additional information is very valuable as it indicates, e.g., that the dotted texture is the most relevant feature for this particular prediction, or that color is a very relevant cue (e.g., the masked reference samples for channel C₁₀ are all red and for channel C₁₈₇ contain only black/brown eyes). As shown in FIG. 7b, channel-conditional explanations computed with CRP help to localize and understand channel concepts by providing masked reference samples (explaining by example).

FIG. 7c shows an example of a concept atlas, which further eases to comprehend the relevant concepts. Technically, the atlas visualizes which concepts are most relevant (solid colored regions) (and here, second most relevant: dotted regions) in specific input image regions. By choosing super-pixels as regions of interest, we can aggregate the channel-conditional relevances per super-pixel into regional relevance scores, as discussed in Section 4. Here, the concept atlas indicates that the “red spot” and “black eye” concepts are most relevant at the bird's head, while the two “dots” concepts mostly fill the upper body part. Interestingly, a stripe of red color in the tail feathers of the bird is detected and used by the model, as indicated by the “red spot” concept being second-most relevant in this region. Alternatively to investigating the most relevant channels overall as in FIG. 7b, a region of interest, e.g. a super-pixel, can be chosen and its most relevant concepts studied. As illustrated in FIG. 7c, CRP relevances can further be used to construct a concept atlas, visualizing which concepts dominate in specific regions in the input image defined by super-pixels. Here, the most relevant channels in layer layer3.0.conv2 can be identified with concepts “dots” (channel C₂₁₀ and C₁₃₀), “red spot” (C₁₀), “black eyes” (C₁₈₇) and “stripes-like” (C₁₉).

With the selection of a specific neuron or concept, CRP allows investigating, how relevance flows from and through the chosen network unit to lower-level neurons and concepts, as is discussed in Section 4.1. This gives information about which lower-level concepts carry importance for the concept of interest and how it is composed of more elementary conceptual building blocks, which may further improve the understanding of the investigated concept and model as a whole. FIG. 7d, shows a Concept Composition graph decomposing a concept of interest given a particular prediction into lower-layer concepts, thus improving concept understanding. Shown are relevant (sub)-concepts in a portion 226₃ of the ML predictor, e.g. a layer, referred to as “features.24” and a portion 226₂, referred to as “features.26” for concept “animal on branch” in a portion 226₁, referred to as “features.28” for the prediction of class 218₁ “Bee Eater” of the output. The relevance flow is highlighted in arrows 231, with the relative percentage of relevance flow to the lower-level concepts. in parentheses. Following the relevance flow, concept “animal on branch” of channel C₁₀₂ is dependent on concepts describing the branch (e.g., “slightly angled bar” of channel C₅₄ and “brown, knobby” of channel C₁₁₈, which both are sub-concepts of the concept “crossed bars of channel C₅₁”) and colorful plumage (e.g., “colorful feathers” of channel C₁₆₂ and “colorful threads” of channel C₄₀₇, which are sub-concepts of the concept “colorful, bushy feathers” of channel C₅₀₆). The relative global relevance score (wrt. channel C₁₀₂ in features.28 (portion 226₁)) of channels C₁₆₂, C₄₀₇, C₅₄, C₁₁₈, C₅₀₆, and C₅₁ are 2.6%, 2.4%, 1.2%, 0.8%, 5.1%, and 3.8%, respectively. In other words, FIG. 7d visualizes an example of an analysis of the backward flow of relevance scores. The graph-like visualization reveals how concepts in higher layers are composed of lower layer concepts. FIG. 7d shows the top-2 concepts influencing our concept of choice, the “animal on branch” concept encoded in a portion 226₁, named “features.28”, of a VGG-16 model trained on ImageNet. Edges in red color indicate the flow of relevance wrt. to the particular sample from class 218₁ “Bee Eater” of the output shown to the very right between the visualized filters with corresponding examples and (multi)-conditional heatmaps. The width of each arrow 231 describes the relative strength of contribution of lower layer concepts to their upper layer neighbors. This example shows that different paths in the network potentially activate the filter. Here, concepts that encode feathers, threads or fur together with horizontal structures are responsible for the activation of filter C₁₀₂ in the observed layer in this particular case.

### 2.2 Understanding Concept Impact and Reach

In this section, it is described how CRP can be leveraged as a Human in the Loop (HITL) solution for dataset analysis. In a first step, embodiments of methods are described, which uncover a Clever Hans artifact [18], suppress it by selectively eliminating the most relevant concepts in order to assess its decisiveness for the recognition of the correct class of a particular data sample. Then, embodiments of methods are described, which utilize class-conditional reference sampling (cf. Section 4) to perform an inverse search to identify multiple classes making use of the filter encoding the associated concept, both in a benign and a Clever Hans sense.

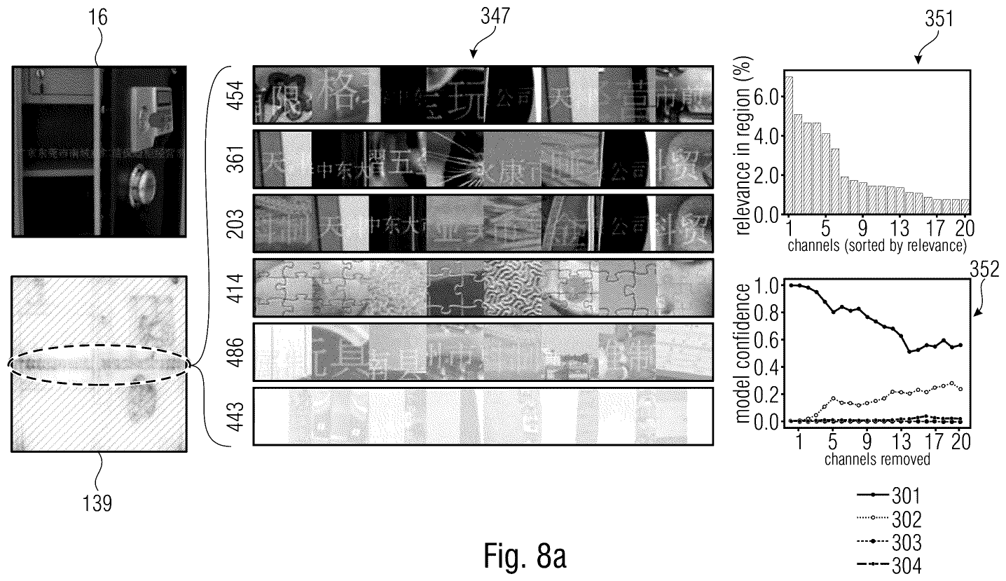

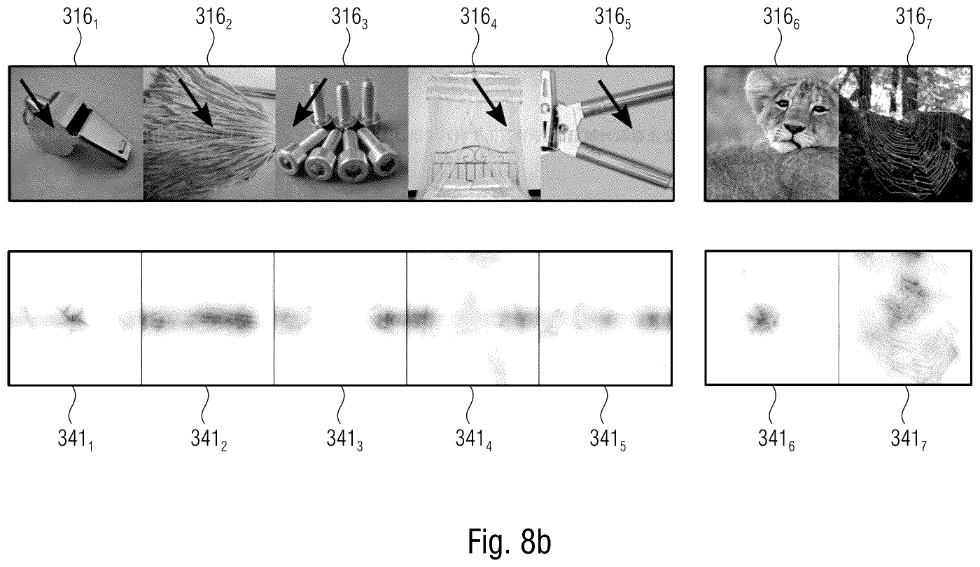

FIG. 8, comprising FIG. 8a and FIG. 8b, illustrates the usage of concept-level explanations for model and data debugging according to an embodiment. FIG. 8a illustrates an example of a local analysis on the attribution map, which reveals several channels 454, 361, 414, 203, 486, 443 and more in layer features.30 of a VGG-16 model with BatchNorm pretrained on ImageNet that encode for a Clever Hans feature exploited by the model to detect the safe class. Reference sign 16 refers to the Input image and reference sign 139 to the respective heatmap. Reference sign 347 referst to reference samples [symbol] for the 6 most relevant channels 454, 361, 414, 203, 486, 443 in the selected region in descending order of their relevance contribution from left to right. Diagram 351 shows the relevance contribution of 20 most relevant filters inside the region. These filters are successively set to zero and the change in prediction confidence of different classes, namely class “safe” 301, class “lock” 302, class “monitor” 303, and class “pay-phone” 304 is recorded and shown in diagram 352. In particular, FIG. 8a shows the analysis of a sample of the “safe” class of ImageNet in a pretrained VGG-16 BN model. Initially, an input attribution map 139 highlighting a centered horizontal band of the image, where a watermark is located, is obtatined. If we take a closer look at layer features.30 and perform a local analysis (cf. Section 4) on the watermark, we notice that the five most relevant filters are 454, 361, 414, 203 and 486. Visualizing them using

Activation Maximization (ActMax) as illustrated in Section 4.2, we conclude that they approximately encode for white strokes. Using the herein disclosed Relevance Maximization (RelMax) approach, which uses CRP for identifying the most relevant samples, allows to gain a deeper insight into the model's preferred usage of the filters and discover that the model utilizes them to detect white strokes in “written characters”. To test the robustness of the model against this Clever Hans artifact, we successively set the activation output map of the 20 most relevant filters activating on the watermark to zero. In diagram 352 of FIG. 8a, we record the change of classification confidence of four classes with the highest prediction confidence for this sample. From the graph, it can be inferred that the Clever Hans filters focussing on the watermark help the model in prediction, but they are not decisive for correct classification. Thus, the model relies on other potential non-Clever Hans features to detect the safe, verifying the correct functioning of the model in cases of samples without watermarks.

In an inverse search, it can then be explored, for which samples and classes these filters also generate high relevance. This allows to understand the behavior of the filter in more detail and to find other possible contaminated classes. FIG. 8b illustrates the seven most relevant classes for filter 361, in particular input images 316₁, 316₂, 316₃, 316₄, 316₅, 316₆, 316₇ classified to classes “whistle”, “mob”, “screw”, “mosquito net”, “can opener”, “puma” and “spiderweb”, respectively, along with respective conditional heatmaps 341₁, 341₂, 341₃, 341₄, 341₅, 341₆, 341₇ for an attribution flow filtered with respect to channel 361. Surprisingly, many classes including “whistle”, “mob”, “screw”, “mosquito net”, “can opener” and “safe” (among others) in the ImageNet Challenge 2014 data are contaminated with similar watermarks encoded via filter 361 of features.30 which is used for the correct prediction of samples from those classes. To verify our finding, we locate via CRP the source of the filters' relevance wrt. the true classes in input space and confirm that these filters indeed activate on the characters. This implies that the model has learned a shared Clever Hans artifact spanning over multiple classes to achieve higher accuracy in classification. The high number of contamination of samples with the identified artifactual feature could be explained by the fact that watermarks are sometimes difficult to see with the naked eye (location marked with a black arrow in FIG. 8b) and thus slip any quality ensuring data inspection. The impact of this image characteristic can, however, be clearly marked using the CRP heatmap. Although the filter is mainly used to detect characters, there are also valid use cases for the model, such as for the puma's whiskers or the spider's web, see images 316₆, 316₇ and corresponding conditional heatmaps 316₆, 316₇, classified as “puma” and “spiderweb”, respectively. This suggests that the complete removal of Clever Hans concepts through pruning may harm the model in its ability to predict other classes which make valid use of the filter, and that a class-specific correction [2] might be more appropriate. In other words, as illustrated in FIG. 8b), the previously identified Clever Hans filter 361 plays a role for samples of different classes (most relevant reference samples shown). Here, black arrows point to the location of a Clever Hans artifact, i.e., a white, delicate font overlaid on images (best to be seen in a digital format). In the case of class “puma” or “spiderweb”, the channel activates on the puma's whiskers or the web itself, respectively. Below the reference samples, the CRP heatmaps conditioned on filter 361 and the respective true class y illustrate, which part of their attribution map would result from filter 361.

### 2.3 Understanding Concept Subspaces, (Dis)Similarities and Roles

In the above described embodiments, the conditional attribution flow or relevance propagation was described based on the non-limiting example of using single filters as functions assumed to (fully) encode learned concepts. Consequently, we have visualized examples and quantified effects based on per-filter granularity. While previous work suggest that individual neurons or filters often encode for a single human comprehensible concepts, it can generally be assumed that concepts are encoded by sets of filters. The learned weights of potentially multiple filters might correlate and thus redundantly encode the same concept, or the directions described by several filters situated in the same layer might span a concept-defining subspace. In this section, we now aim to investigate the encodings of filters of a given neural network layer for similarities in terms of activation and use within the model.

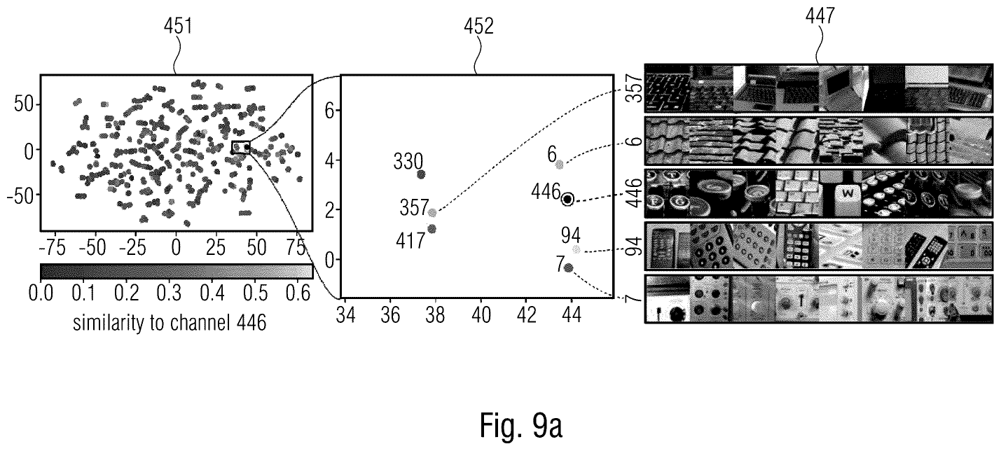

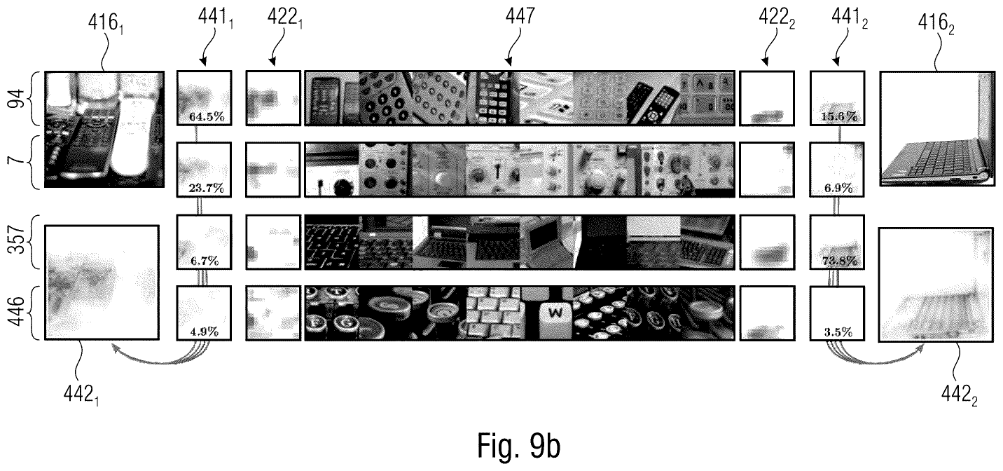

FIG. 9, comprising FIG. 9a and FIG. 9b, illustrates a method of finding similarity of concepts and analyzing fine-grained decision making according to an embodiment. FIG. 9a illustrates an example of a concept similarity clustering of latent space. Diagram 451 shows channels from layer features.40 of a VGG-16 with BatchNorm, clustered and embedded according to ρ-similarity (see Section 4.3). Markers are colored according to their ρ-similarity to filter 446. One particular cluster around channel 446 is shown in more detail in diagram 452 with five similarly activating channels and their reference images [symbol] obtained via RelMax. As per the reference images, the over-all concept of the cluster seems to be related to keyboard keys, round buttons as well as rectangular roofing shingles, as shown by sets 447 of most relevant samples of these channels. In other words, FIG. 9a shows an analysis result focusing on a cluster around filter 446 from features.40 of a VGG-16 network with BatchNorm layers trained on ImageNet. The reference samples 447 show various types of typewriter and rectangular laptop keyboard buttons and roofing shingles photographed in oblique perspective, as well as round buttons of typewriters, remote controls for televisions, telephone keys and round turnable dials of various devices and machinery. Thus, the filters around filter 446 seem to cover different aspects of a shared “button” or “small tile” concept. The filters located in this cluster have been identified as similar due to their similar activations over sets of analyzed reference samples (see Section 4.3). Assuming redundancy based on the filter channels' apparently similar activation behavior, a human could merge them to one encompassing concept, thereby simplifying interpretation by reducing the number of filters in the model.

FIG. 9b shows a further investigation of the filters 7, 94, 446 and 357 (all showing buttons or keys) in order to find out (1) whether they encode a concept collaboratively, (2) whether they are partly redundant, or (3) whether the cluster serves some discriminative purpose. FIG. 9b visualizes the reference samples 447 of these four filters for the most-relevant classes “laptop computer” and “remote control”. For each of these classes, an exemplary input image 416₁, 416₂ is shown. During a forward pass through the model, filter activations are computed using instances of both classes as input, as well as filter-conditioned CRP maps for the samples' respective ground truth class label. Regardless of whether an instance from class “laptop” or “remote control” is chosen as input, the activation maps 422 across the observed channels 94 “round, flat keys”, 7 “round knobs”, 357 “computer keyboard keys”, and 446 “typewriter keys & keyboards” are in part similar, e.g., they all (except channel 7) activate on the bottom part for the right input image. The per-channel CRP attribution map 441, however, reveals that while all filters react to similar stimuli in terms of activations, the model seems to use the subtle differences among the observed concepts to distinguish between the classes “laptop” and “remote control”. In both cases, buttons are striking and defining features, and all observed filters activate for button features. However, when computing the conditional heatmaps with CRP for class “laptop”, the activating filters representing round buttons (filters 7, 94, and 446) dominantly receive negative attribution scores, while filter 357 clearly representing typical keyboard button layouts receives high positive relevance scores. For samples of class “remote control”, the computation of relevance scores wrt. their true class yields almost exactly opposite attributions, indicating that filters encoding round buttons and dials (filters 94 and 7) provide evidence for class “remote control”, while the activation of channel 357 clearly speaks against the analyzed class as visible in the conditional heatmaps. In both relevance analyses, however, filter 446 receives weak negative attributions, presumably as it represents a particular expression of both round and angular buttons which fits (or contradicts) neither of the compared classes particularly well. In fact, filter 446 is highly relevant for class “typewriter keyboard” instead. In other words, FIG. 9b illustrates an example for a fine-grained decision making based on a relevance-based investigation of the previously identified similarly activating channels of FIG. 9a. Reference sign 447 relates to reference examples for the identified filters with similar underlying theme. FIG. 9b further shows exemplary input 416₁ from class “remote control” with per-channel activation maps 422₁ and respective ground truth CRP relevance maps 442₁, as well as their aggregation 442₁ θ={L:{y}, features.40: {c₉₄, c₇, c₃₅₇, c₄₄₆}}. FIG. 9b further shows exemplary input 416₂ from class “laptop computer” with per-channel activation maps 422₂ and respective ground truth CRP relevance maps 441₂, as well as their aggregation 442₂. Conditional relevance attributions R(x|θ) are normalized wrt. the common maximum amplitude. Similarly activating channels do not necessarily encode redundant information, but might be used by the model for making fine-grained distinctions, which can be observed from the attributed relevance scores.

To summarize, embodiments of the present invention exploit the finding that although several filters may show signs of correlation in terms of output activation, they are not necessarily encoding redundant information or are serving the same purpose. Conversely, using the herin disclosed CRP in combination with the RelMax-based process for selecting reference examples representing seemingly correlating filters, allows to discover and understand the subtleties a neural network has learned to encode in its latent representations.

### 3 Discussion

Embodiments of the present invention provide CRP, a post-hoc explanation method, which not only indicates which part of the input is relevant for an individual prediction, but may also communicate the meaning of involved latent representations by providing human-understandable examples. Since CRP combines the benefits of the local and global XAI perspective, it computes more detailed and contextualized explanations, considerably extending the state-of-the-art. Among its advantages are the high computational efficiency (order of a backward pass) and the out-of-the-box applicability to (almost) any model without imposing constraints on the training process, the data and label availability, or the model architecture. Furthermore, CRP introduces the idea of conditional backpropagation tied to a single concept or a combination of concepts as encoded by the model, within or across layers. Via this ansatz, the contribution of all neurons' concepts in a layer can be faithfully attributed, localized in the input space, and finally their interaction can be studied. As shown in this work, such an analysis allows one to disentangle and separately explain the multitude of in-parallel partial forward processes, which transform and combine features and concepts before culminating into a prediction. Finally, with RelMax we move beyond the decade-old practice of communicating latent features of neural networks based on examples obtained via maximized activation. In particular, we show that the examples which stimulate hidden features maximally are not necessarily useful for the model in an inference context, or representative for the data the model is familiar and confident with. By providing examples based on relevance, however, the user is presented with data with characteristics which actually play an important role in the prediction process. Since the user can select examples wrt. any (i.e., not necessarily the ground truth) output class, the disclosed approach constitutes a new tool to systematically investigate latent concepts in neural networks.

The above discussed experiments have qualitatively and quantitatively demonstrated the additional value of the CRP approach for common datasets and end-to-end trained models. Specifically, they showed that reference samples selected with relevance-based criteria, concept heatmaps and atlases, as well as concept composition graphs open up the ability to understand model reasoning on a more abstract and conceptual level. These insights then allow to identify Clever Hans concepts, to investigate their impact, and finally to correct an ML model for these misbehaviors. Further, using relevance-based reference sample sets, embodiments of the disclosed method enables to identify concept themes spanned by sets of filters in latent space. Although channels of a cluster have a similar function, they seem to be used by the model for fine-grained decisions regarding details in the data, such as the particular type of buttons to partially decide whether an image shows a laptop keyboard, a mechanical typewriter or a TV remote control. Finally, embodiments of the herein disclosed CRP method are useful in non-image data domain, where traditional attribution maps are often difficult to interpret and comprehend by the user. Our experiments on time series data have shown that as long as a visualization of the data can be found, the meaning of latent concepts can be communicated via reference examples.

Overall, embodiments of the tools proposed in this disclosure, and the resulting increase in semantics and detail to be found in sample-specific neural network explanations, allows to advance the applicability of post-hoc XAI to novel or previously difficult to handle models, problems and data domains.

### 4 Methods

This section presents embodiments of the techniques used and introduced in this disclosure.

### 4.1 Concept Relevance Propagation

In the following, an embodiment of CRP is described, a backpropagation-based attribution method extending the framework of Layer-wise Relevance Propagation (LRP) [4]. As such, CRP inherits the basic assumptions and properties of LRP.

The description starts with a description of LRP. Assuming a predictor with L layers

$$f ( x ) = {f}_{L} ∘ … ∘ {f}_{1} ( x ) , \qquad ( 1 )$$

LRP follows the flow of activations computed during the forward pass through the model in opposite direction, from the final layer f_{L} back to the input mapping f₁. Given a particular mapping f_{*}(⋅), we consider its pre-activations zᵢⱼ mapping inputs i to outputs j and their aggregations zⱼ at j. Commonly in neural network architectures such a computation is given with

$${z}_{i j} = {a}_{i} {w}_{i j} \qquad ( 2 )$$

$${z}_{j} = {\sum }_{i} {z}_{i j} \qquad ( 3 )$$

$${a}_{j} = σ ( {z}_{j} ) , \qquad ( 4 )$$

where aᵢ are the layer's inputs and wᵢⱼ its weight parameters. Finally, σ constitutes a (component-wise) non-linearity producing input activation for the succeeding layer(s). The LRP method distributes relevance quantities Rⱼ corresponding to aⱼ and received from upper layers towards lower layers proportionally to the relative contributions of zᵢⱼ to zⱼ, i.e.,

$${R}_{i ← j} = \frac{{z}_{i j}}{{z}_{j}} {R}_{j} . \qquad ( 5 )$$

Lower neuron relevance is obtained by losslessly aggregating all incoming relevance messages R_{i←j} as

$${R}_{i} = {\sum }_{j} {R}_{i ← j} . \qquad ( 6 )$$

This process ensures the property of relevance conservation between a neuron j and its inputs i, and thus adjacent layers. LRP is mathematically founded in Deep Taylor Decomposition [23].

In the following, a method, referred to as CRP, according to embodiments of the present invention is described. CRP extends the formalism of LRP by introducing conditional relevance propagation determined by a set of conditions θ. Each condition c∈θ can be understood as an identifier for neural network elements, such as neurons j located in some layer, representing latent encodings of concepts of interest. One such condition could, for example, represent a particular network output to initiate the backpropagation process from. Within the CRP framework, the basic relevance decomposition formula of LRP given in Equation (5) then becomes

$${R}_{i ← j}^{( l - 1 , l )} ( x \vert θ ⋃ {θ}_{l} ) = \frac{{z}_{i j}}{{z}_{j}} \cdot {\sum }_{{c}_{l} ∈ {θ}_{l}} {δ}_{j {c}_{l}} \cdot {R}_{j}^{l} ( x \vert θ ) , \qquad ( 7 )$$

following the potential for a “filtering” functionality briefly discussed in [24]. Here, Rⱼ^{l}(x|θ) is the relevance assigned to layer output j given from the CRP process performed in upper layers under conditions θ, to be distributed to lower layers. The sum-loop over cₗ∈θₗ then “selects” via the Kronecker-Delta δ_{jc}_{ₗ} neurons j of which the relevance is to be propagated further, given j corresponds to concepts as specified in set θₗ specific to layer l. The result is the concept-conditional relevance message R_{i←j}^{(l-1,l)}(x|θ∪θₗ) carrying the relevance quantities wrt. the prediction outcome on x conditioned to θ and θₗ. Note that the sum is not particularly necessary in Equation (7), but serves as a means to compare all possible cₗ for identity to the current j. In practice [1], CRP can be implemented efficiently as a single backpropagation step by binary masking of relevance tensors, and is compatible to the recommended rule composites for relevance backpropagation [22, 17].

FIG. 10, comprising FIGS. 10a-c, illustrates an explanation disentanglement via an embodiment of CRP. As illustrated in FIG. 10a, a target concept 551 “dog” (θ_{d}) is described by a combination of lower-level concepts such as concept 552 “snout” (θ_{ds}), concept 554 “eye” (θ_{de}), and concept 553 “fur” (θ_{df}). CRP heatmaps 141 regarding individual concepts, and their contribution to the prediction of “dog”, can be generated by applying masks to filter-channels in the backward pass. Global (in the context of an input sample) relevance of a concept wrt. to the explained prediction can thus not only be measured in latent space 509, but also precisely visualized, localized and measured in input space 517. The concept-conditional computation of R(x|θ_{df}) reveals the relatively high importance of the spatially distributed “fur” feature for the prediction of “dog”, compared to the feature “eye”. Diagram 559 indicates the global relevances 562, 563, 564, and 565 of the concepts “snout”, “eye”, “fur”, and “others”, respectively. The attribution of R(x|θ_{df}) in the input space visualization of R(x|θ_{d}) (which was computed jointly over all concepts), however, is dominated by R(x|θ_{de}) and R(x|θ_{ds}) which both concentrate more strongly on smaller image regions and attribute both to the dog's eye. Here, the visualization of R(x|θ_{d}) alone does not represent the relative importance of the concepts' contributions to the “dog” outcome. FIG. 10b illustrates an example of a local relevance aggregation according to embodiments. According to these embodiments, CRP may be applied in combination with local aggregation of relevance scores R(x|θ) over regions of interest 571, e.g. [symbol] and [symbol] in the conditional heatmap 541 of FIG. 10b, in order to locally assess conceptual importance and localize concepts involved in inference. FIG. 10c illustrates a hierarchical concept composition according to an embodiment. Given Rⱼ^{l}(x|θ) for a particularly interesting concept encoded by channel j in layer l, relevance quantities computed during a CRP backward pass can then be utilized to identify how Rⱼ^{l}(x|θ) distributes across lower layer channels (here shown side-by-side in an exploded view), representing concepts, as R_{i←j}^{(l-1,l)}(x|θ) (reference sign 573 in FIG. 10c). The identification of the most influential concepts in layer l−1 contributing to channel j in layer l wrt. an explanation computed regarding θ is then just a matter of ranking R_{i←j}^{(l-1,l)}(x|θ), e.g., by (signed) magnitude.

One effect of CRP over LRP and other attribution methods is an increase in detail of the obtained explanations, as illustrated with FIG. 10. Given a typical image classification Convolutional Neural Network (CNN), one may assume the computation of three-dimensional latent tensors, where the first two axes span the application coordinates of n spatially invariant convolutional filters, which generate output activations stored in the n channels of the third axis. For simplicity, one can further assume that each filter channel is associated to exactly one latent concept. Neurons j can thus be grouped into spatial and channel axes in order to restrict the application of CRP conditions θₗ to the channel axis only, i.e.,

$${R}_{i ← ( p , q , j )}^{( l - 1 , l )} ( x \vert θ ⋃ {θ}_{l} ) = \frac{{z}_{i ( p , q , j )}}{{z}_{( p , q , j )}} \cdot {\sum }_{{c}_{l} ∈ {θ}_{l}} {δ}_{j {c}_{l}} \cdot {R}_{( p , q , j )}^{l} ( x \vert θ ) . \qquad ( 8 )$$

Here, the tuple (p, q, j) uniquely addresses an output voxel of the activation tensor z_{(p,q,j)} computed during the forward pass with p and q indicating the spatial tensor positions and j the channel. FIG. 10a exemplarily contrasts the attribution-based explanation wrt. class “dog” only (which also is possible with LRP and other attribution methods) as θ_{d}={dog}, to the attributions for, e.g., “dog\hat{ }fur” as θ_{df}={fur, dog} (or θ_{df}={l: {fur}, L: {dog}}, to provide a more explicit notation specifying the affiliation of concepts to distinct layers.) (possible with CRP only) by conditionally masking channels responsible for fur pattern representations. Here we use the terms fur and dog describing latent or labelled concepts, respectively, as proxy representations for network element identifiers c. We further assume that in any layer l′ without explicit designation of conditions all δ_{*}-operators always evaluate to 1 to not restrict the flow of attributions through these layers.

Due to the conservation property of CRP inherited from LRP, the global relevance of individual concepts to per-sample inference can be measured by summation over input units i as

$${R}^{l} ( x \vert θ ) = {\sum }_{i} {R}_{i}^{l} ( x \vert θ ) , \qquad ( 9 )$$

in any layer l where θ has taken full effect. This can easily be extended to a localized analysis of conceptual importance, by restricting the relevance aggregations to regions of interest

[symbol]

$${R}_{𝒥}^{l} ( x \vert θ ) = {\sum }_{i ∈ 𝒥} {R}_{i}^{l} ( x \vert θ ) , \qquad ( 10 )$$

as illustrated in FIG. 10b. Additionally, as shown in FIG. 10c, an aggregation of the relevance messages may be utilized to identify dependencies of a concept c encoded by channels j, to concepts encoded by channels i in a lower layer, in context of the prediction of a sample x and CRP-conditions θ. With an expansion of the indexing of downstream target voxels wrt. Equation (9) as

$${R}_{( u , v , i ) ← ( p , q , j )}^{( l - 1 , l )} ( x \vert θ ) = \frac{{z}_{( u , v , i ) ( p , q , j )}}{{z}_{( p , q , j )}} {R}_{( p , q , j )}^{l} ( x \vert θ ) , \qquad ( 11 )$$

the tuple (u, v, i) addresses the spatial axes with u and v, and the channel axis i at layer l−1. An aggregation over spatial axes with

$${R}_{i ← j}^{( l - 1 , l )} ( x \vert θ ) = {\sum }_{u , v} {\sum }_{p , q} {R}_{( u , v , i ) ← ( p , q , j )}^{( l - 1 , l )} ( x \vert θ ) \qquad ( 12 )$$

communicates the dependency between channel j to lower-layer channel i, and thus related concepts, in terms of relevance in the prediction context of sample x. Following the LRP methodology, an adaptation of the CRP approach beyond CNN, e.g., to recurrent [3] or graph [36] neural networks, is possible.

In the following, optional features of CRP are described in more detail, starting from LRP.

### 4.1.1 LRP

LRP may be regarded a white-box attribution method grounded on the principles of flow conservation and proportional decomposition. Its application is aligned to the layered structure of machine learning models. Assuming a model with L layers

$$f ( x ) = {f}_{L} ∘ … ∘ {f}_{1} ( x ) , \qquad ( 1 )$$

LRP may follow the flow of activations and pre-activations computed during the forward pass through the model in opposite direction, from the final layer f_{L} back to the input mapping f₁. Let us consider some (internal) layer or mapping function f_{*}(⋅) in the model. Within such a layer, LRP assumes the computation of pre-activations zᵢⱼ, mapping inputs i to outputs j, which are then aggregated as zⱼ at j, e.g., by summation. Commonly, in neural network architectures, such a computation is given with

$${z}_{ij} = {a}_{i} {w}_{ij} \qquad ( 2 )$$

$${z}_{j} = {\sum }_{i} {z}_{ij} \qquad ( 3 )$$

$${a}_{j} = σ ( {z}_{j} ) , \qquad ( 4 )$$

where aᵢ are the input activations passed from the previous layer and wᵢⱼ are the layer's learned weight parameters, mapping inputs i to layer outputs j. Note that the aggregation by summation to zⱼ can be generalized, e.g., to also support max-pooling by formulating the sum as a p-means pooling operation. Finally, σ constitutes a (component-wise) non-linearity producing input activation for the succeeding layer(s). In order to be able to perform its relevance backward pass, Irp assumes the relevance score of a layer output j as given as Rⱼ. The algorithm usually starts by using any (singular) model output of interest as an initial relevance quantity. In its most basic form, the method then distributes the quantity Rⱼ towards the neuron's input as

$${R}_{i ← j} = \frac{{z}_{ij}}{{z}_{j}} {R}_{j} , \qquad ( 5 )$$

i.e., proportionally wrt. the relative contribution of zᵢⱼ to zⱼ. Lower neuron relevance is obtained by simply aggregating all incoming relevance messages R_{i←j} without loss:

$${R}_{i} = {\sum }_{j} {R}_{i ← j} \qquad ( 6 )$$

This proportionality simultaneously ensures a conservation of relevance during decomposition as well as between adjacent layers, i.e.,

$${\sum }_{i} {R}_{i} = {\sum }_{i} {\sum }_{j} {R}_{i ← j} = {\sum }_{j} {\sum }_{i} \frac{{z}_{ij}}{{z}_{j}} {R}_{j} = {\sum }_{j} {R}_{j} . \qquad ( 7 )$$

Note, that above formalism, at the scope of a layer, introduces the variables i and j as the inputs and outputs of the whole layer mapping, and assumes zᵢⱼ=0 for unconnected pairs of i and j, as it is the case in single applications of filters in, e.g., convolutional layers. For component-wise non-linearities σ in Equation (4), commonly implemented by, e.g., the tanh or ReLU functions which (by lrp) typically are treated as a separate layer instances, this results in zᵢⱼ=δᵢⱼzⱼ (with δᵢⱼ being the Kronecker-Delta representing the input-output connectivity between all i and j) and consequently in an identity backward pass through o. This principle of attribution computation by relevance decomposition can be implemented and executed efficiently as a modification of gradient backpropagation.

In order to ensure robust decompositions and thus stable heatmaps and explanations, several purposed LRP rules may be applied, for which Equations (5) and (6) serve as a conceptual basis. A composite strategy, mapping different rules to different parts of a neural network may qualitatively and quantitatively increases attribution quality for the intent of explaining prediction outcomes. In the following analysis, different composite strategies are therefore used.

### 4.1.2 Disentangling Explanations with CRP

LRP, like other backpropagation-based methods, may compute attribution scores for all hidden units of a neural network model in order to allot a score to the model input. While in some recent works those hidden layer attribution scores have been used as a (not further semantically interpreted) means to improve deep models, or as proxy representations of explanations for the identification of systematic Clever Hans behavior, they are usually disregarded as a “by-product” for obtaining per-sample explanations in input space. The reason is fairly simple: End-to-end learned representations of data in latent space are usually difficult (or impossible) to interpret, other than the samples in input space, e.g., images. Using attribution scores for rating the importance of individual yet undecipherable features and their activations does not provide any further insight about the model's inference process.

Assuming an understanding of the distinct roles of latent filters and neurons in end-to-end learned DNN. Then, another problem emerges for interpreting model decisions in input space, rooted in the mathematics of modified backpropagation approaches. As Equation (7) summarizes for intermediate layers, LRP (and related approaches) propagates quantities from all layer outputs j simultaneously to all layer inputs i. This leads at a layer input to a weighted superposition of attribution maps received from all upper layer representations, where detailed information about the individual roles of interacting latent representations is lost. What remains is a coarse map identifying the (general) significance of an input feature (e.g., a pixel) to the preceding inference step. A notable difference to this superimposing backpropagation procedure within the model is the initialization of the backpropagation process, where usually only one network output, of which the meaning (e.g., representation of categorical membership) generally is known, is selected for providing an initial relevance attribution quantity, and all others are masked by zeroes. This guarantees that an explanation heatmap represents the significance of (input) features to only the model output of choice. Let us call this heatmap representation a (class or output) conditional relevance map R(x|y) specific to a network output y and a given sample x. Would one backpropagate all network outputs simultaneously, as it is demonstrated in FIG. 1a, class-specificity would be lost, and again only information about “some” not further specified feature importance could be obtainable. Still, even class-specific attribution maps can be uninformative, as shown in FIG. 1b. Here, attributions tend to mark the same body parts for all bird species, as a result of attribution scores specific to latent concepts superposed in input space. In all explanations, we see that, e.g., the bird's head seems to be of importance. We do not know, however, whether the animal's eyes or beak carry some individual characteristics recognized and utilized by the model.

In the following, embodiments are described which use different strategies for disentangling attribution scores for latent representations in order to increase the semantic fidelity of explaining heatmaps via CRP. We introduced the notion of a class-or output-conditional relevance quantity R(x|y) for describing the use of knowledge about the meaning of particular neural network neurons and filters and their represented concepts—here the categories represented by the neurons at the model output. The key idea for obtaining R(x|y) is the masking of unwanted network outputs prior to the backpropagation process via a multiplication with zeroes. Perpetuating the notation introduced in the previous Section 4.1.1, obtaining the attribution scores Rᵢ¹(x|y) for input units i corresponding to the individual components, features or dimensions xᵢ of input sample x at layer l=1 and model output category y is achievable by initializing the layer-wise backpropagation process with the initial relevance quantity Rⱼ^{L}(x|y)=δ_{jy}fⱼ^{L}(x), with fⱼ^{L}(x) being the model output of the j-th neuron at output layer L. Using the Kronecker-Delta δ_{jy}, only the output of the neuron corresponding to the output category y is propagated in the backward pass. Let us uphold our assumption of knowledge about the concepts encoded by each filter or neuron within a DNN. We generalize the principle of masking or selecting the model output for a particular outcome to be explained by introducing the variable θ describing a set of conditions ct bound to representations of concepts and applying to layers l. Multiple such conditions in combination might extend over multiple layers of a network. Note that we use natural numbers as identifying indicators for neural network filters (or elements in general) in compliance to the Kronecker Delta. Here, θ then allows for a (multi-) concept-conditional computation of relevance attributions R(x|θ).

We therefore extend the relevance decomposition formula in Equation (5), following the potential for a “filtering” functionality to

$${R}_{i ← j}^{( l - 1 , l )} ( x \vert θ ⋃ {θ}_{l} ) = \frac{{z}_{ij}}{{z}_{j}} \cdot {\sum }_{{c}_{l} ∈ {θ}_{l}} {δ}_{{jc}_{l}} \cdot {R}_{j}^{l} ( x \vert θ ) \qquad ( 8 )$$

where δ_{jc}_{ₗ} “selects” the relevance quantity Rⱼ^{l} of layer l and neuron j for further propagation, if j meets the condition(s) cₗ tied to concepts we are interested in. Note that for layers l′ without explicitly selected conditions, our notation assumes all conditions applicable in that layer to be valid, i.e., if θ_{l′}=Ø is an empty set, we define ∀j∃!c_{l′}∈θ_{l′}:c_{l′}=j and therefore ∀jΣ_{c}_{_{l′}}_{∈θ}_{ₗ}δ_{jc}_{_{l′}}=1. Thus, without conditions, attribution flow is not constrained, as no masking is applied. Furthermore, due to our approach based on binary masking, which controls the flow of backpropagated quantities through the model, this assumption illustrates that a combination of conditions within a layer l behaves similarly to a logical OR (∨) operator, and combinations of conditions across layers behave similar to logical AND (∧) operators.

### Possible Analyses with CRP

The most basic form of relevance disentanglement is the masking of neural network outputs for procuring class-specific heatmaps. Here, heatmaps gain (more) detailed meaning by specifying a class output for attribution distribution, answering the question of “which features are relevant for predicting (against) a chosen class”. Backpropagation-based XAI methods also assign attribution scores to neurons of intermediate layers, and thus further reveal the relevance of hidden neurons for a prediction. Regarding DNNs, these hidden neurons can represent human-understandable concepts. It has been shown that the meaning of filters in a neural network is hierarchically organized within its sequence of layered representations, meaning that an abstract latent representation within the model is based on (weighted) combinations of simpler concepts in lower layers. Such concepts can be allocated to individual neurons or groups of neurons, e.g., a filter or filters of a convolutional layer of a dnn. By introducing (multi-)conditional CRP, i.e., via a masking of hidden neurons, the relevance contribution of individual concepts used by a neural network can be, in principle, disentangled and individually investigated as well. This expands the information horizon to questions such as “how relevant a particular concept is for the prediction”, or “which features are relevant for a specific concept”.

### Local Concept Importance

Visualizations of concept-conditional relevance in heatmaps show where concepts contributing to a chosen network output are localized and recognized by the model in the input space. Typically, as discussed in Section 4.1, an explanation heatmap regarding a singular specific output class may be described by a combination of interactions of individual concepts. The bar chart in the bottom left of FIG. 10a illustrates how class-conditional attribution maps (here, for class “dog”) can be separated into the individual contributions of learned concepts using further refinement of the attribution backpropagation wrt. conceptual conditioning, on a global scale in context of the given sample. At this point, given Rᵢ^{l}(x|θ_{c}), conceptual disentanglement allows measuring the individual importance of the in θ_{c} selected concepts c on a local scale, i.e., over a subset [symbol] of neurons i in layer l. Specifically, relevance scores Rᵢ^{l}(x|θ_{c}) in, e.g., input space, can be aggregated meaningfully over image regions for the concept c to a localized relevance score

$${R}_{𝒥}^{l} ( x \vert {θ}_{c} ) = {\sum }_{i ∈ 𝒥} {R}_{i}^{l} ( x \vert {θ}_{c} ) \qquad ( 11 )$$

measuring the importance of a concept to the prediction on a set of given input features, e.g., pixels. Extending the notation introduced in Equation (9), for a convolutional layer with J channels, local relevance aggregation along the spatial axis is given by

$${R}_{𝒥}^{l} ( x \vert {θ}_{c} ) = {\sum }_{( p , q ) ∈ 𝒥} {\sum }_{j = 1}^{𝒥} {R}_{( p , q , j )}^{l} ( x \vert {θ}_{c} ) , \qquad ( 12 )$$

aggregating over all positions (p, q) defined in the set [symbol] .

For methods adhering to a conservation property such as CRP, this property permits the comparison of multiple local image regions [symbol] and/or sets of concepts c in terms of (relative) importance of learned latent concepts, as illustrated in FIG. 10b. In the given example we compute relevance scores according to θ_{ds}, θ_{de}, θ_{df}, et cetera, individually in input space.

Then we aggregate the resulting attribution maps according to Equation (11) over two input regions [symbol] and [symbol] in order to locally measure the relative importance of by the model perceived concepts. As seen later, the capabilities of localized crc can be utilized to visualize a “Concept Atlas” which demonstrates which concepts models perceive and use locally for their decision making process.

### 4.2 Selecting Reference Examples

In the following, we discuss the widely-used Activation Maximization approach to procuring representations for latent neurons, and present a novel CRP-based Relevance Maximization technique to improve concept identification and understanding.

### 4.2.1 Activation Maximization

A large part of feature visualization techniques rely on ActMax, where in its simplest form, input images are sought that give rise to the highest activation value of a specific network unit. Recent work [45, 8] proposes to select reference samples from existing data for feature visualization and analysis. In the literature, the selection of reference samples for a chosen concept c manifested in groups of neurons is often based on the strength of activation induced by a sample. For data-based reference sample selection, the possible input space [symbol] is restricted to elements of a particular finite dataset [symbol] ⊂ [symbol] . The authors of [8] assume convolutional layer filters to be spatially invariant. Therefore, entire filter channels instead of single neurons are investigated for convolutional layers. One particular choice of maximization target [symbol] (x) is to identify samples x*∈ [symbol] , which maximize the sum over all channel activations, i.e.,

$${𝒯}_{sum}^{act} ( x ) = {\sum }_{i} {z}_{i} ( x ) . \qquad ( 13 )$$

resulting in samples x*ₛᵤₘ^{act} which are likely to show a channel's concept in multiple (spatially distributed) input features, as maximizing the entire channel also maximizes [symbol] . However, while targeting all channel neurons, reference samples including both concept-supporting and contradicting features might result in a low function output of [symbol] , as negative activations are taken into account by the sum. Alternatively, a non-linearity can be applied on zᵢ(x), e.g., ReLU, to only consider positive activations. A different choice is to define maximally activating samples by observing the maximum channel activation

$${𝒯}_{max}^{act} ( x ) = {max}_{i} {z}_{i} ( x ) , \qquad ( 14 )$$

leading to samples x*ₘₐₓ^{act} with a more localized and strongly activating set of input features characterizing a channel's concept. These samples x*ₘₐₓ^{act} might be more difficult to interpret, as only a small region of a sample might express the concept.

In order to collect multiple reference images describing a concept, the dataset [symbol] consisting of n samples is first sorted in descending order according to the maximization target [symbol] , i.e.

$${𝒳}^{*} = \{ {x}_{1}^{*} , … , {x}_{n}^{*} \} = arg {{sort}_{x ∈ {𝒳}_{d}}}^{desc} 𝒯 ( x ) . \qquad ( 15 )$$

Subsequently, we define the set

$${𝒳}_{k}^{*} = \{ {x}_{1}^{*} , … , {x}_{k}^{*} \} ⊆ {𝒳}^{*} \qquad ( 16 )$$

containing the k≤n samples ranked first according to the maximization target to represent the concept of the filter(s) under investigation. We denote the set of samples obtained from [symbol] as [symbol] and the set obtained from [symbol] as [symbol] .

### 4.2.2 Relevance Maximization

We introduce the method of RelMax as a complement to ActMax. Regarding RelMax, we do not search for images that produce a maximal activation response. Instead, we aim to find samples, which contain the relevant concepts for a prediction. In order to select the most relevant samples, we define maximization targets [symbol] by using the relevance Rᵢ(x|θ) of neuron i for a given prediction, instead of its activation value zᵢ. Specifically, the maximization targets are given as

$${𝒯}_{sum}^{rel} ( x ) = {\sum }_{i} {R}_{i} ( x \vert θ ) \qquad ( 17 )$$

$$and$$

$${𝒯}_{max}^{rel} ( x ) = {max}_{i} {R}_{i} ( x \vert θ ) .$$

FIG. 11, comprising FIGS. 11a-d, illustrates activation-and relevance-based sample selection according to embodiments. FIG. 11a illustrates an activation flow 131 and a relevance flow 141 according to embodiments. Activation scores only measure the stimulation of a latent filter without considering its role and impact during inference. Relevance scores are contextual to distinct model outputs and describe how features are utilized in a DNN's prediction of, e.g., a specific class. FIG. 11b illustrates reference samples 601 selected based on activation [symbol] and reference samples 602 selected based on relevance [symbol] for each two filters (upper and lower line). Samples selected based on ActMax only represent maximized latent neuron activation, while samples based on RelMax represent features which are actually useful and representative for solving a prediction task. FIG. 11c illustrates an evaluation of the activation regarding its usefulness for a layer with ReLU activation. Assume one wishes to find representative examples for features x₁ and x₂. Even though a sample leads to a high activation score in a given layer and neuron (group)—here x₁ and x₂—in FIG. 1 feature groups 603₁ and 603₂ are selected by activation [symbol] for x₁ and x₂, respectively, and feature groups 604₁ and 604₂ are selected by relevance [symbol] for x₁ and x₂, respectively—it does not necessarily result in high relevance or contribution to inference: The feature transformation \vec{w} of a linear layer with inputs x₁ and x₂, which is followed by a ReLU non-linearity, is shown. Here, samples from the blue cluster of feature activations lead to high activation values for both features x₁ and x₂, and would be selected by ActMax, but receive zero relevance, as they lead to an inactive neuron output after the ReLU, and are thus of no value to following layers. That is, even though the given samples activate features x₁ and x₂ maximally strong, they can not contribute meaningfully to the prediction process through the context determined by \vec{w}, and samples selected as representative via activation might not be representative to the overall decision process of the model. Representative examples selected based on relevance, however, are guaranteed to play an important role in the model's decision process. FIG. 11d illustrates a measuring of activation and relevance, in particular, Correlation analyses are shown for an intermediate ResNet layer's channel and neuron. Diagram 608 shows data for one channel, diagram 609 for a single neuron. Bars 641 represent relevance, bars 642 counts. Neurons that are on average highly activated are not, in general, also highly relevant, as a correlation coefficient of c=0.111 for the channel shows, since a specific combination of activation magnitudes is important for neurons to be representative in a larger model context. The correlation coefficient for the single neuron is c=0.547.

By utilizing relevance scores Rᵢ(x|θ) instead of relying on activations only, the maximization target [symbol] or [symbol] is class- (true, predicted or arbitrarily chosen, depending on θ), model-, and potentially concept-specific (depending on θ), as illustrated in FIG. 11a. The resulting set of reference samples thus includes only samples which depict facets of a concept that are actually useful for the model during inference (see FIG. 11b). How differences in resulting reference sets [symbol] and [symbol] can occur, is depicted in FIG. 11c-d. One can see that relevances are not strictly correlated to activations, because they also depend on the downstream relevances propagated from higher layers affected by feature interactions at the current and following layers.

### 4.3 Comparing Feature Channels with Averaged Cosine Similarity on Reference Samples

We propose a simple but qualitatively effective method for comparing filters in terms of activations based on reference samples, for grouping similar concepts in CNN layers. Based on the notation in previous sections, [symbol] denotes a set of k reference images for a channel q in layer l and z_{q}^{l}(W, xₘ) the ReLU-activated outputs of channel q in layer l for a given input sample xₘ with all required network parameters W for its computation. Specifically, for each channel q and its associated full-sized (i.e. not cropped to the channels' filters' receptive fields) reference samples xₘ∈ [symbol] we compute zₘ^{q}=z_{q}^{l}(W, xₘ), as well as zₘ^{p}=zₚ^{l}(W, xₘ) for all other channels p≠q, by executing the forward pass, yielding activation values for all spatial neurons for the channels. We then define the averaged cosine similarity ρ_{qp} between two channels q and p in the same layer l as

$${ρ}_{qp} = \frac{1}{2} ( {cos ( ϕ )}_{qp} + {cos ( ϕ )}_{pq} ) \qquad ( 18 )$$

$$with$$

$${cos ( ϕ )}_{qp} = \frac{1}{k} {\sum }_{{x}_{m} ∈ {𝒳}_{{( k , q )}_{sum}^{rel}}^{*}} \frac{{z}_{m}^{q} \cdot {z}_{m}^{p}}{‖ {z}_{m}^{q} ‖ \cdot ‖ {z}_{m}^{p} ‖} . \qquad ( 19 )$$

Note that we symmetrize ρ_{qp} in Equation (18) as the cosine similarities cos(ϕ)_{qp} and cos(ϕ)_{pq} are in general not identical, due to the potential dissimilarities in the reference sample sets [symbol] and [symbol] . Thus, cos(ϕ)_{qp} measures the cosine similarity between filter q and filter p wrt. the reference samples representing filter q. The from Equation (18) resulting symmetric similarity measures ρ_{qp}=ρ_{pq}∈[0,1] can now be clustered, and visualized via a transformation into a distance measure d_{qp}=1−ρ_{qp} serving as an input to t-SNE [44] which visually clusters similar filters together in, typically, [symbol] . Note that

normally, the output value of the cosine distance covers the interval [−1,1], where for −1 the two measured vectors are exactly opposite to one another, for 1 they are identical and for 0 they are orthogonal. In case output channels of dense layers are analyzed, i.e. scalar values, the range of output values reduces to the set {−1,0,1}, as both values are either of same or different signs, or at least one of the values is zero. Since we are processing layer activations after the ReLU nonlinearities of the layer, which yields only positive values for zₘ^{q} and zₘ^{p}. This results in ρ_{pq}∈[0,1], and a conversion to a canonical distance measure d_{qp}∈[0,1].

### SECTION C—FURTHER APPLICATIONS

In general, the filtered reverse propagation disclosed herein, e.g. the CRP algorithm, may allow gaining more detailed insight into the inference compared to previous methods. While reverse propagating an inference result from the predictor output to the input data structure may limit the investigation to a predefined concept associated with the inference result, filtering the reverse propagation allows revealing concepts associated with predictor portions, which are not predefined in the model training, but which develop during model training, i.e. which are developed by the predictor itself.

Furthermore, by filtering the reverse propagation, for a concept associated with a specific inference result, sub-concepts on which the concept is built, may be revealed. In other words, the filtered reverse propagation may provide details about a concept of an inference result, and may thus lead to explanations that are more detailed.

In the following, advantages of the invention with respect to some applications are described.

A General Application would be to use the Relevance Score Assignment (RS assignment) proposed here as part of a larger, more complex algorithm (CA). One can think of situations where it is very expensive to apply algorithm CA, so our RS assignment could define some regions of interest where algorithm CA could be applied. For example,
the time of a medical doctor is precious. RS assignment can identify the important regions in an image when screening for cancer. The described relevance score assignment may provide details about the inference, e.g., which elements/sub-region of a relevant region of interest are relevant.
in video coding the channel bandwidth is precious. RS assignment could inform algorithm CA about which parts of the video are more important than others e.g. to determine a better coding strategy (e.g. using more bits for important parts) or a better transmission schedule (e.g. transmit important information first). E.g., based on the context of encoded concepts, one could assign higher bandwidth to representations of faces, less bandwith to representations of e.g. foliage or background features.
the heatmap could be used for computing additional features for some prediction task. For instance we could use a trained network, apply it to some image and extract more features from regions which are more important. This may result in reduction of computation time or transmission of information. Alternatively the regions or additional information extracted from it could be used to retrain and improve the trained network.
RS assignment could be used as an investigative tool in the case where a user or company would like to know what regions or features are important for a certain task. filtered reverse propagation may provide information on how those regions are understood by the predictor, and what they represent.
Conditional Relevance Scores (CRS) wrt select concepts encoded via portions of the network may be utilized for a reverse search of data structures (to use the terms established in the present CRP application), eg by ranking data structures wrt to their relevance attributed (reflecting the contribution or use of a concept to prediction) to concept-encoding network portions. Data structures can thus be selected based on their expression of concepts learned by a NN model, and may serve as a means for data retrieval.
In a similar manner, network outputs/output categories/downstream portions of a network can be ranked according to their attributed relevance to upstream portions of the network encoding latent concepts, i.e. by measuring how said downstream neurons “make use of” upstream portions of the network. This can be used to rank/Identify downstream portions of the network, which make use of a particular/predetermined upstream portion of the network. In particular, the network output categories encoded by output neurons may be ranked. This can be used to identify network outcomes which are most/least affected by some effects encoded by upstream network portions, and might be of use for auditing or re-assessing AI-based records (use case: which AI outcome was predominantly made based on this biased concept encoded by this upstream portion?)
Once concepts could be identified and assigned to some portion of the network, relevance scores filtered wrt these portions can be used for labelling data sources based on the semantics of those neurons. This can be used as a means for fine-grained label assignment based on the understanding of the network of the given data, ie Al-based knowledge discovery and data (re)categorization based on AI perspektive. Massive potential for saving (manual) labelling time.
In a similar spirit, the conditional attribution maps of CRP can be used to localize (un)important data content, eg for selecting time and locations in videos to assign more/less bandwith for encoding (faces vs background shrubbery, etc)
Furthermore, the filtered reverse propagation may provide information on which decisions of a model can make are affected by a specific concept identified in the model, cf. the above-described Chinese characters on safes and other classes.

Further, in the Image Application field,
RS assignment can be used in medical applications, e.g. as aid for doctors in identifying tumors in pathological images or identify observations in MRI images. More concrete examples include:
   detection of inflammation signs in images of biological tissues,
   detection of cancer signs in images of biological tissues,
   detection of pathological changes in images of biological tissues,
RS assignment can be applied to general images. For instance, social website platforms or search engines have many images and may be interested in what makes an image ‘funny’, ‘unusual’, ‘interesting’ or what makes a person, an image of housing or interiors of houses attractive/aesthetic or less attractive/less aesthetic.
In particular, the filtered reverse propagation allows to find/rank not only predefined categories such as “funny”, “unusual”, etc., but allows for finding/ranking according to any potentially previously unknown/unlabelled concept learned (and represented by hidden units of the model) by the model on its own.
RS assignment can be used in surveillance applications to detect which part of the image triggers the system to detect an unusual event.
Detection of land use changes in images taken by satellites, aircrafts or remote sensing data.

In the Video Application field,
Heatmaps can be used to set the compression strength of coding, e.g., using more bits for areas containing important information and less bits for other areas. For example, the filtered reverse propagation may allow for identifying these areas, and in particular, may allow for region semantics being contextually selected based on meaning of latent encodings, e.g. not only predefined categories.
RS assignment can be used for video summarization, i.e. to identify ‘relevant’ frames in a video. This would allow intelligent video browsing.
Animated movies sometimes do not look very realistic. It is not clear what is ‘missing’ to make the movies look more realistic. Heatmaps can be used in this case to highlight unrealistic portions of the video.

In the case of Text Applications,
The classification of text documents into categories can be performed by DNNs or BoW models. RS assignment can visualize why documents are classified into a specific class. The relevance of a text for a topic can be highlighted or selected for further processing. RS assignment could highlight important words and thus provide a summary of a long text. Such systems could be useful for e.g. patent lawyers to quickly browse many text documents.

In the case of Financial Data Applications,
Banks use classifiers such as (deep) neural networks to determine whether someone gets a credit loan or not (e.g. the German Schufa system). It is not transparent how these algorithms work, e.g. some people who do not get a credit don't know why. RS assignment could exactly show why someone does not get the credit. And in extension, portions of the model encoding discriminatory information, if found to affect the model inference, may be identified and suppressed/pruned/deactivated in order to produce a second, unbiased creditworthyness assessment.

In the field of Marketing/Sales,
RS assignment could be used to determine what makes a particular product description image/text sell the product (e.g. apartment rental, ebay product description).
RS assignment could be used to determine what makes an online video/blog post highly viewed or liked
Companies may be in general interested what ‘features’ makes e.g. their website or product attractive.
Companies are interested in why some users buy a product and others don't buy it. RS assignment can be used to identify the reason for users not to buy a product and improve the advertisement strategy accordingly.

In the Linguistics/Education field
RS assignment could be used to determine which part of a text differentiates native from non-native speakers for a particular language such as English, French, Spanish or German.
RS assignment can be used to find elements of proof in the text that a document has been written by a particular person, or not.

In the above description, different embodiments have been provided for assigning relevance scores to a set of items. For example, examples have been provided with respect to pictures. In connection with the latter examples, embodiments have been provided with respect to a usage of the relevance scores, namely in order to highlight relevant portions in pictures using the relevance scores, namely by use of a conditional heatmap which may be overlaid with the original picture. In the following, embodiments, which use or exploit the relevance scores are presented, i.e. embodiments which use the above-described relevance score assignment as a basis.

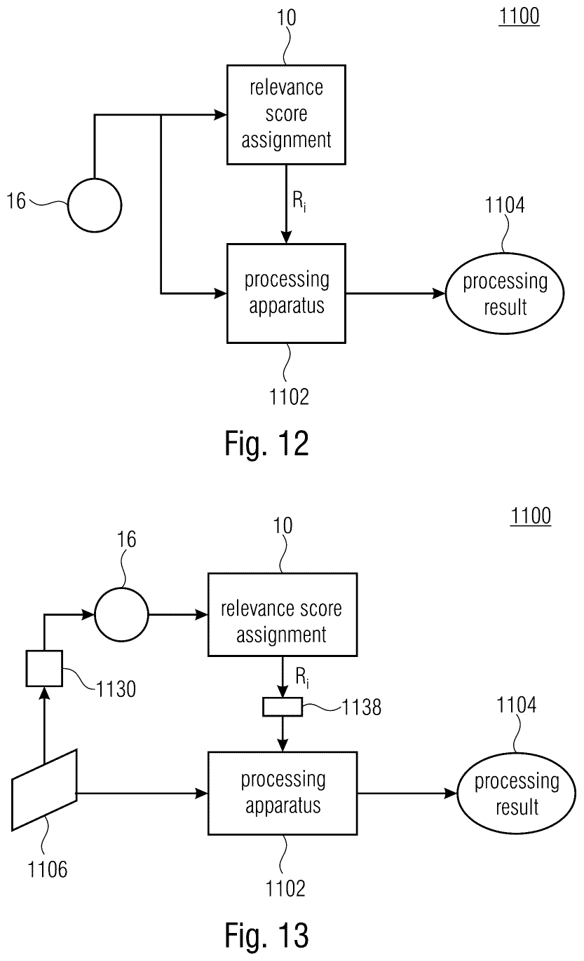

FIG. 12 illustrates a system for processing a set of items according to an embodiment. The system is generally indicated using reference sign 1100. The system comprises, besides apparatus 10, configured for performing the assignment of a relevance score to portions of the data structure 16, e.g. apparatus 10 of FIG. 1a, 1b. a processing apparatus 1102. Portions of the data structure may be referred to as items of a set 16 in the following. Both apparatus 10 and apparatus 1102 operate on the set 16, e.g. the data structure 16 of FIG. 1a, 1b. The processing apparatus 1102 is configured to process the set of items, i.e. set 16, in order to obtain a processing result 1104. In doing so, processing apparatus 1102 is configured to adapt its processing depending on the relevance scores Rᵢ having been assigned to the items of set 16 by relevance score assigner 50. Apparatus 50 and apparatus 1102 may be implemented using software running on one or more computers. They may be implemented on separate computer programs or on one common computer program. With respect to set 16, all of the examples presented above are valid. For example, imagine that processing apparatus 1102 performs a lossy processing such as data compression. For example, the data compression performed by apparatus 1102 may include irrelevance reduction. Set 16 may, for instance, represent image data such as a picture or video and the processing performed by apparatus 1102 may be a compression of lossy nature, i.e. the apparatus may be an encoder. In that case, apparatus 1102 may, for instance, be configured to decrease the lossiness of the process for items having higher relevance scores assigned thereto than compared to items having lower relevance scores assigned thereto. The lossiness may, for example, be varied via quantization step size or by varying the available bitrate of a rate control of the encoder. For example, areas of samples for which the relevance score is high may be coded less lossy such as using higher bitrate, using lower quantization step size or the like. Thus, the relevance score assignment performs its relevance score assignment, for example, with respect to a detection/prediction of suspect persons in a video scene. In that case, processing apparatus 1102 is able to spend more data rate in lossy compressing the video, which in accordance with this example represents set 16, with respect to interesting scenes, i.e. spatiotemporal portions being of interest because suspects have been “detected” within same. Or the processing apparatus 1102 uses the same data rate, but due to the weighting achieved by the relevance scores, the compression is lower for items of samples with high relevance scores and the compression is higher for items of samples with low relevance scores.The processing result 1104 is in that case the lossy compressed data or data stream, i.e. the compressed version of video 16. However, as mentioned before, set 16 is not restricted to video data. It may be a picture or an audiostream or the like.

For the sake of completeness, FIG. 13 shows a modification of the system of FIG. 12. Here, a relevance score assignment 10 operates on set 16 (data structure 16) in order to derive the relevance scores Rᵢ for the items of set 16, but processing apparatus 1102 operates on data to be processed 1106 which is not equal to set 16. Rather, set 16 has been derived from data 1106. FIG. 13, for example, illustrates the exemplary case according to which set 16 has been derived from data 1106 by feature extraction process 1130. Thus, set 16 “describes” data 1106. The relevance values Rᵢ may, in a manner described above, be associated with the original data 1106 via a reverse mapping process 1138, which represents a reversal or reverse mapping with respect to feature extraction process 30. Thus, processing apparatus 1102 operates on data 1106 and adapts or streamlines its processing dependent on the relevance scores Rᵢ.

The processing performed by processing apparatus 1102 in FIGS. 12 and 13 is not restricted to a lossy processing such as a lossy compression. For example, in many of the above examples for set 16 or data 1106, the items of set 16 form an ordered collection of items ordered in 1, 2 or more dimensions. For example, pixels are ordered in at least 2-dimensions, namely x and y are the two lateral dimensions, and 3-dimensions when including the time axis. In the case of audio signals, the samples such as as time domain (e.g. PCM) samples or MDCT coefficients are ordered along a time axis. However, the items of set 16 may also be ordered in a spectral domain. That is, the items of set 16 may represent coefficients of a spectral decomposition of, for example, a picture, video or audio signal. In that case, process 1130 and reverse process 1138 could represent a spectral decomposition or forward transformation or an inverse transformation, respectively. In all of these cases, the relevance scores Rᵢ as obtained by the relevance score assigner 10 are likewise ordered, i.e. they form an ordered collection of relevance scores, or in other words, form a “relevance map” which may be overlaid with set 16 or, via processing 1138, data 1106. Thus, processing apparatus 1102 could, for example, perform a visualization of set 16 of data 1106 using the order among the items of set 16 or the order of the samples of data 1106 and use the relevance map in order to highlight a relevant portion of the visualization. For example, the processing result 1104 would be a presentation of a picture on a screen and using the relevance map apparatus 1102 highlighting some portion on the screen using, for example, blinking, color inversion or the like, in order to indicate a portion of increased relevance in set 16 or data 1106, respectively. Such a system 1100 could, for instance, be used for the purpose of video surveillance in order to draw, for example, the attention of security guards onto a certain portion of a scene represented by data 1106 or set 16, i.e. a video or picture, for example.

Alternatively, the processing performed by apparatus 1102 may represent a data replenishment. For example, the data replenishment may refer to a reading from a memory. As another alternative, the data replenishment may involve a further measurement. Imagine, for example, that set 16 is again an ordered collection, i.e. is a feature map belonging to a picture 1106, is a picture itself or a video. In that case, processing apparatus 1102 could derive from the relevance scores Rᵢ in information of an ROI, i.e. a region of interest, and could focus the data replenishment onto this ROI so as to avoid performing data replenishment with respect to the complete scene which set 16 refers to. For instance, the first relevance score assignment could be performed by apparatus 10 on a low resolution microscope picture and apparatus 1102 could then perform another microscope measurement with respect to a local portion out of the low resolution microscope picture for which the relevance scores indicate a high relevance. The processing result 1104 would accordingly be the data replenishment, namely the further measurement in the form of a high resolution microscope picture.

Thus, in the case of using system 1100 of FIG. 12 or 13 for the purpose of controlling the data rate expenditure, system 1100 results in an efficient compression concept. In the case of using system 1100 for visualization processes, system 1100 is able to increase the likelihood that a viewer realizes some region of interest. In the case of using system 1100 in order to streamline a data replenishment, system 1100 is able to avoid the amount of data replenishment by avoiding the performance of data replenishment with respect to areas of no interest.

In other words, FIG. 12 and FIG. 13 illustrate a system 1100 for data processing according to an embodiment, the system 1100, comprising an apparatus 10 configured for assigning respective relevance scores to portions of a data structure 16, e.g. apparatus 10 of FIG. 1, and an apparatus 1102 for processing of the data structure 16 (e.g. FIG. 12) or data to be processed 1106 and derived from the data structure (e.g. FIG. 13) with adapting the processing depending on the relevance scores.

According to an embodiment, the processing is a lossy processing and the apparatus for processing is configured to decrease a lossiness of the lossy processing for portions of the data structure having higher relevance scores assigned therewith than compared to portions of the data structure having lower relevance scores assigned therewith.

According to an embodiment, the processing is a visualizing, wherein the apparatus for adapting is configured to perform a highlighting in the visualization depending on the relevance scores.

According to an embodiment, the processing is a data replenishment by reading from memory or performing a further measurement wherein the apparatus 1102 for processing is configured to focus the data replenishment depending on the relevance scores.

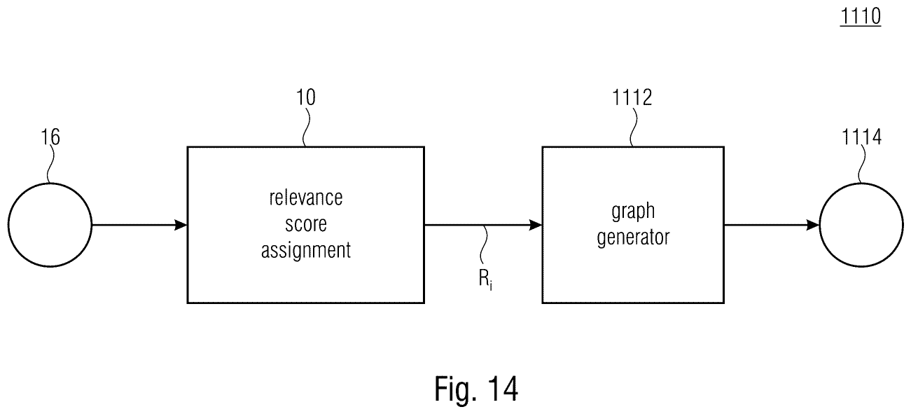

FIG. 14 shows a system 1110 for highlighting a region of interest of a set of items according to an embodiment. That is, in the case of FIG. 14, the set of items is again assumed to be an ordered collection, such as a feature map, a picture, a video, an audio signal or the like. The relevance score assigner 10 is comprised by system 1110 in addition to a graph generator 1112, which generates a relevance graph depending on the relevance scores Rᵢ provided by relevance score assigner 10. The relevance graph 1114 may, as already described above, be a heatmap where color is used in order to “measure” the relevances Rᵢ. The relevance sores Rᵢ are, as described above, scalar, or same may be made scalar by summing-up mapping relevance scores belonging together such as relevance scores of sub-pixels of different color components belonging to one color pixel of an image. The scalar relevance scores Rᵢ may then be mapped onto grey scale, or color with using, for example, the individual pixel's one-dimensional scalar relevance scores as CCT (Corrected Color Temperature) value, for instance. However, any mapping from one dimension to a three dimensional color space like RGB can be used for generating a colored map. For example one maps the scores onto an interval of hues, fix the saturation and value dimensions and then transforms the HSV (hue-saturation-value) representation into an RGB representation.

However, the relevance graph 1114 may, alternatively, be represented in the form of a histogram or the like. A graph generator 1112 may include a display for displaying the relevance graph 1114. Beyond this, graph generator 1112 may be implemented using software such as a computer program which may be separate to or included within a computer program implementing relevance score assigner 10.

As a concrete example, imagine that the set 16 of items is an image. The pixel-wise relevance scores for each pixel obtained in accordance with the assigner may be discretized/quantized into/onto a set of values and the discretization/quantization indices may be mapped onto a set of colors. The mapping may be done in graph generator 1112. The resulting assignment of pixels to colors, i.e. such as an “heatmap” in case of the relevance-color mapping following some CCT (color temperature)-measure for the colors, can be saved as an image file in a database or on a storage medium or presented to a viewer by generator 1112.

Alternatively the assignment of pixels to colors can be overlaid with the original image. In that case, the processor 1102 of FIGS. 12 and 13 could act as a graph generator. The resulting overlay image can be saved as an image file on a medium or presented to a viewer. The “overlaying” may be done, for example, by turning the original image into a greyscale image, and use for the mapping of the pixel-wise relevance scores to color values a mapping to hue values. An overlay image can be created by the processor 1102 by using the HSV representation, i.e. the value (however with a cap on too small values because an almost black pixel has no clearly visible colors, and possibly also the saturation is taken from the original image,) is gained from a respective sample's grey scale value of the original image's grey scale version and the hue values are taken from the color map. Processor 1102 could subject an image generated as just outlined, e.g. the color map or the overlay or the ordered set of relevance scores (which can be represented as an image, but this is not a requirement), to segmentation. Those segments in such a segmented image, which correspond to regions with scores which are very high or to regions with scores which have large absolute values, could be extracted, stored in a database or a storage medium and used (with or without subsequent manual inspection) as additional training data for a classifier training procedure. If the set 16 of items is text, the outcome of the relevance assignment could be a relevance a score per word or per sentence as described above. The relevance score could then be discretized into a set of values and mapped onto a set of colors. The words could then, by processor 1102, be marked by the color, the resulting color-highlighted text could be saved in a database or on a storage medium or presented to a human. Alternatively or additionally to highlighting the words, the processor 1102 merely selects a subset of words, sentence parts or sentences of the text, namely those with the highest scores or the highest absolute values of scores (e.g. by thresholding of the score or its absolute value) and save this selection in a database or on a storage medium or present it to a human. If the relevance assignment is applied to a data set 16 such that a sample consists of a set of key value pairs, for example finance data about companies, stored in a table in a database, then the outcome for each sample would be a relevance score per key-value pair. For a given sample, a subset of key-value pairs with the highest scores or the highest absolute values of scores (e.g. by thresholding of the score or its absolute value) could then be selected and this selection could be saved in a database or on a storage medium or present it to a human. This could be done by processor 1102 or generator 1112.

It has already been outlined above with respect to FIG. 12, that the data set 16 may be an image or a video. The pixel-wise relevance scores may then be used to find regions with high scores. To this end, the above mentioned segmentation or a video segmentation may exemplarily be used. In case of a video, a region of high score would be a spatio-temporal subset or portion of the video. For each region, a score per region, for example by computing a p-mean

$${M}_{p} ( {x}_{1} , … , {x}_{N} ) = {( \frac{1}{N} {\sum }_{i = 1}^{N} {x}_{i}^{p} )}^{\frac{1}{p}}$$

or a quantile of the pixel-wise scores for the pixels of the region could be computed. The data set, e.g. the video, would then be subject to a compression algorithm by processor 1102 for which the compression rate can be adjusted for regions according to the computed score. A monotonous (falling or rising) mapping of region scores to compression rates could be used. Each of the regions would then be encoded according to the mapping of the region scores to compression rates.

Further, the processor 1102 could act as follows in case of an image as the set 16: The just outlined segmentation could be applied to the set of scores for all pixels or to an overlay image or to the color map, and segments corresponding to regions with scores which are very high or to regions with scores which have large absolute values, may be extracted. The processor may then present these co-located segments of the original image 16 to a human or another algorithm for checking of content for possibility of conspicuous or anomalous content. This could be used, for example, in security guard applications. Likewise, the set 16 could be a video. The whole video, in turn, is composed of a set of frames. An item in the set 16 of items could be a frame or a subset of frames or a set of regions from a subset of frames as already stated above. Spatio-temporal video segmentation could be applied to the relevance score assignment to the items, as to find spatio-temporal regions with either high average scores for the items or high average absolute values of scores for the items. As mentioned above, the average scores assigned to items within a region could be measured for example using a p-mean or a quantile estimator. The spatio-temporal regions with highest such scores, such as scores above some threshold, can be extracted by processor 1102 (for example by means of image or video segmentation) and presented to a human or another algorithm for checking of content for possibility of conspicuous or anomalous content. The algorithm for checking could be included in the processor 1102, or could be external thereto with this being true also for the above occasions of mentioning the checking of regions of high(est) score.

In accordance with an embodiment, the just-mentioned spatio-temporal regions with highest such scores are used for the purpose of training improvement for predictions made on videos. As stated, the set 16 of items is the whole video which can be represented by a set of frames. An item in the set of items is a frame or a subset of frames or a set of regions from a subset of frames. Video segmentation is then applied to find spatio-temporal regions with either high average scores for the items or high average absolute values of scores for the items. Processor 1102 may select neurons of the neural network which are connected to other neurons such that via indirect connections above regions are part of the input of the selected neurons. Processor 1102 may optimize the neural network in the following way: given the input image and a neuron selected as above (for example by having direct or indirect inputs from regions with high relevance scores or high absolute values of them), processor 1102 tries to increase the network output or the square of the network output, or to decrease the network output by changing the weights of the inputs of the selected neuron and the weights of those neurons which are direct or indirect upstream neighbors of the selected neuron. Such a change can be done for example by computing the gradient of the neuron output for the given image with respect to the weights to be changed. Then the weights are updated by the gradient times a stepsize constant. Needless to say, that the spatio-temporal region may also be obtained by segmentation of pixel-wise scores, i.e. by using pixels as the items of set 16, with then performing the optimization which was outlined above.

Even alternatively, the relevance assignment may be applied to graph data consisting of nodes, and directed or undirected edges with or without weights; an item of set 16 would then be a subgraph, for example. An element-wise relevance score would be computed for each subgraph. A subgraph can be an input to a neural network for example if it is encoded as an integer by encoding nodes and their edges with weights by integer numbers while separating semantic units by integers which are reserved as stop signs. Alternatively, an item of set 16 for computing the relevance score per item could be a node. Then we compute item-wise relevance scores. After that a set of subgraphs with high average score could be found (the average score can be computed by p-mean

$${M}_{p} ( {x}_{1} , … , {x}_{N} ) = {( \frac{1}{N} {\sum }_{i = 1}^{N} {x}_{i}^{p} )}^{\frac{1}{p}}$$

or by a quantile of the scores over the nodes) by graph segmentation. The scores for each node are discretized into a set of values and the discretization indices are mapped onto a set of colors. The resulting assignment of nodes and subgraphs to colors and/or the extracted subgraphs can be saved as a file in a database or on a storage medium or presented to a viewer.

In other words, FIG. 14 illustrates a system 1110 for highlighting a region of interest, comprising an apparatus 10 for assigning respective relevance scores to portions 22 of a data structure 16, e.g. as described with respect to FIG. 1, and an apparatus 1112 for generating a relevance graph 1114 depending on the relevance scores.

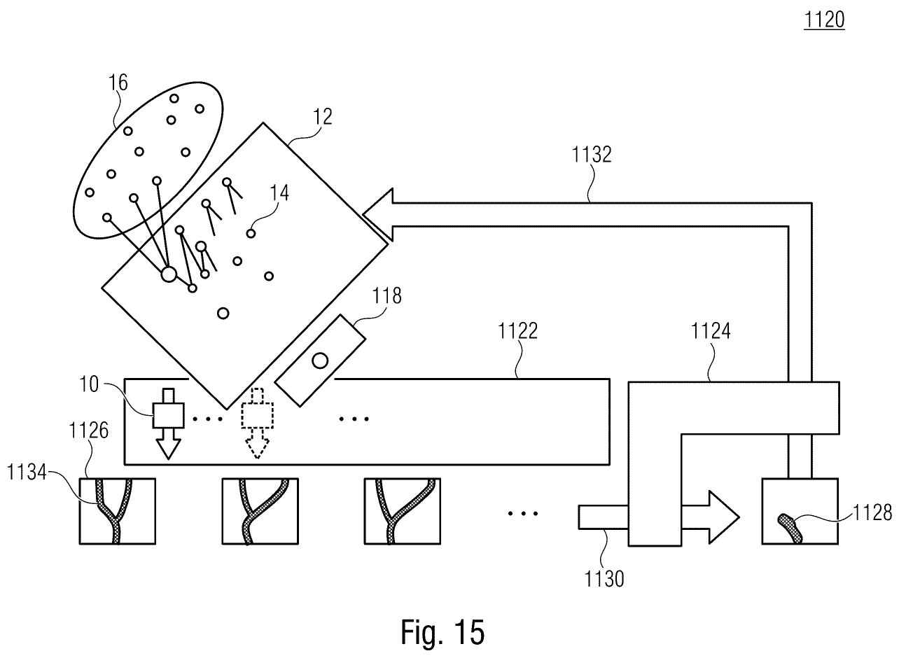

FIG. 15 illustrates a system for optimizing a neural network according to an embodiment. The system is generally indicated using reference sign 1120 and comprises the relevance score assigner 10, an application apparatus 1122 and a detection and optimizing apparatus 1124. The application apparatus 1122 is configured to apply apparatus 10 onto a plurality of different sets 16 of items. Thus, for each application, apparatus 10 determines the relevance scores for the items of set 16. This time, however, apparatus 10 also outputs the relevance values assigned to the individual intermediate neurons 14 (which may be examples of predictor portions 14 of FIG. 1b) of neural network 12 (which may be an example of ML predictor 12 of FIG. 1b) during the reverse propagation, thereby obtaining the aforementioned relevance paths 1134 for each application. In other words, for each application of apparatus 10 onto a respective set 16, detection and optimizing apparatus 1124 obtains a relevant propagation map 1126 of neural network 12. Apparatus 1124 detects a portion 1128 of increased relevance within the neural network 12 by accumulating 1130 or overlaying the relevances assigned to the intermediate neurons 14 of network 12 during the apparatus' 10 application onto the different sets 16. In other words, apparatus 1124 overlays or accumulates, by overlay, the different relevance propagation maps 1126 so as to obtain the portion 1128 of neural network 12 including those neurons which propagate a high percentage of the relevance in the reverse propagation process of apparatus 10 over the population of sets 16. This information may then be used by apparatus 1124 so as to optimize 132 the artificial neural network 12. In particular, for example, some of the interconnections of neurons 14 of artificial neural network 12 may be left off in order to render the artificial neural network 12 smaller without compromising its prediction ability. Other possibilities exist, however, as well.

Further, it may be that the relevance Score Assignment process gives out a heatmap, and that same is analyzed with respect to e.g. smoothness and other properties. Based on the analysis, some action may be triggered. For example, a training of a neural network may be stopped because it captures the concepts “good enough” according to the heatmap analysis. Further it should be noted that the heatmap analysis result may be used along with the neural network prediction results, i.e. the prediction, to do something. In particular, relying on both heatmap and prediction results may be advantageous over relying on only the prediction results only because, for example, the heatmap may tell something about the certainty of the prediction. The quality of a neural network can be potentially evaluated by analysis the heatmap.

In other words, FIG. 15 illustrates a system 1120 for optimizing a neural network, comprising an apparatus 10 configured for assigning respective relevance scores to portions of a data structure 16, e.g. apparatus 10 of FIG. 1; an apparatus 1122 for applying the apparatus for assigning onto a plurality of different data structures; and an apparatus 1124 for detecting a portion of increased relevance 1128 within the neural network by accumulating relevances assigned to units (or neurons) of the ML predictor during the application of the apparatus for assigning onto the plurality of data structures, and optimizing the artificial neural network depending on the portion of increased relevance.

Finally, it is emphasized that the proposed relevance propagation has primarily illustrated above with respect to networks trained on classification tasks, but without loss of generality, the embodiments described above may be applied to any network that assigns a score attributed to output units or output portions. These scores can be learned using other techniques such as regression or ranking.

Thus, in the above description, embodiments have been presented which embody a methodology which may be termed conditional relevance propagation that allows to understand neural network predictors. Different applications of this novel principle were demonstrated. For images it has been shown that pixel contributions can be visualized as heatmaps and can be provided to a human expert who can intuitively not only verify the validity of the classification decision, but also focus further analysis on regions of potential interest. The principle can be applied to a variety of tasks, classifiers and types of data i.e. is not limited to images, as noted above.

### SECTION D—IMPLEMENTATION ALTERNATIVES

This section describes implementation alternatives for the embodiments described in sections A, B and C.

Although some aspects have been described as features in the context of an apparatus it is clear that such a description may also be regarded as a description of corresponding features of a method. Although some aspects have been described as features in the context of a method, it is clear that such a description may also be regarded as a description of corresponding features concerning the functionality of an apparatus.

Some or all of the method steps may be executed by (or using) a hardware apparatus, like for example, a microprocessor, a programmable computer or an electronic circuit. In some embodiments, one or more of the most important method steps may be executed by such an apparatus.

Depending on certain implementation requirements, embodiments of the invention can be implemented in hardware or in software or at least partially in hardware or at least partially in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitory.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are preferably performed by any hardware apparatus.

The apparatus described herein may be implemented using a hardware apparatus, or using a computer, or using a combination of a hardware apparatus and a computer.

The methods described herein may be performed using a hardware apparatus, or using a computer, or using a combination of a hardware apparatus and a computer.

In the foregoing Detailed Description, it can be seen that various features are grouped together in examples for the purpose of streamlining the disclosure. This method of disclosure is not to be interpreted as reflecting an intention that the claimed examples require more features than are expressly recited in each claim. Rather, as the following claims reflect, subject matter may lie in less than all features of a single disclosed example. Thus the following claims are hereby incorporated into the Detailed Description, where each claim may stand on its own as a separate example. While each claim may stand on its own as a separate example, it is to be noted that, although a dependent claim may refer in the claims to a specific combination with one or more other claims, other examples may also include a combination of the dependent claim with the subject matter of each other dependent claim or a combination of each feature with other dependent or independent claims. Such combinations are proposed herein unless it is stated that a specific combination is not intended. Furthermore, it is intended to include also features of a claim to any other independent claim even if this claim is not directly made dependent to the independent claim.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

### REFERENCES

[1] Christopher J. Anders, David Neumann, Wojciech Samek, Klaus-Robert Müller, and Sebastian Lapuschkin. Software for dataset-wide XAI: from local explanations to global insights with Zennit, CoRelAy, and ViRelAy. arXiv preprint arXiv: 2106.13200, 2021.
[2] Christopher J. Anders, Leander Weber, David Neumann, Wojciech Samek, Klaus-Robert Müller, and Sebastian Lapuschkin. Finding and removing clever hans: Using explanation methods to debug and improve deep models. Information Fusion, 77:261-295, 2022.
[3] Leila Arras, Grégoire Montavon, Klaus-Robert Müller, and Wojciech Samek. Explaining recurrent neural network predictions in sentiment analysis. In 8th EMNLP Workshop on Computational Approaches to Subjectivity, Sentiment and Social Media Analysis (WASSA), pages 159-168, 2017.
[4] Sebastian Bach, Alexander Binder, Grégoire Montavon, Frederick Klauschen, Klaus-Robert Müller, and Wojciech Samek. On pixel-wise explanations for non-linear classifier decisions by Layer-Wise Relevance Propagation. PLoS ONE, 10(7):e0130140, 2015.
[5] David Bau, Bolei Zhou, Aditya Khosla, Aude Oliva, and Antonio Torralba. Network dissection: Quantifying interpretability of deep visual representations. In IEEE International Conference on Computer Vision and Pattern Recognition (CVPR), pages 3319-3327, 2017.
[6] David Bau, Jun-Yan Zhu, Hendrik Strobelt, Àgata Lapedriza, Bolei Zhou, and Antonio Torralba. Understanding the role of individual units in a deep neural network. Proc. Natl. Acad. Sci. USA, 117(48):30071-30078, 2020.
[7] Chaofan Chen, Oscar Li, Daniel Tao, Alina Barnett, Cynthia Rudin, and Jonathan K Su. This looks like that: Deep learning for interpretable image recognition. Advances in Neural Information Processing Systems (NeurIPS), 32:8930-8941, 2019.
[8] Zhi Chen, Yijie Bei, and Cynthia Rudin. Concept whitening for interpretable image recognition. Nature Machine Intelligence, 2(12):772-782, 2020.
[9] Commission to the European Parliament, the Council, the European Economic and Social Committee, and the Committee of the Regions. Communication: Building trust in human centric artificial intelligence. COM, 168, 2019.
[10] Zihang Dai, Hanxiao Liu, Quoc Le, and Mingxing Tan. Coatnet: Marrying convolution and attention for all data sizes. Advances in Neural Information Processing Systems (NeurIPS), 34, 2021.
[11] Dumitru Erhan, Yoshua Bengio, Aaron Courville, and Pascal Vincent. Visualizing higher-layer features of a deep network. University of Montreal, 1341(3):1, 2009.
[12] Bryce Goodman and Seth Flaxman. European union regulations on algorithmic decision-making and a “right to explanation”. AI magazine, 38(3):50-57, 2017.
[13] Fred Hohman, Haekyu Park, Caleb Robinson, and Duen Horng Polo Chau. Summit: Scaling deep learning interpretability by visualizing activation and attribution summarizations. IEEE Transactions on Visualization and Computer Graphics (TVCG), 26(1):1096-1106, 2019.
[14] Max Jaderberg, Wojciech M Czarnecki, lain Dunning, Luke Marris, Guy Lever, Antonio Garcia Castaneda, Charles Beattie, Neil C Rabinowitz, Ari S Morcos, Avraham Ruderman, et al. Human-level performance in 3D multiplayer games with population-based reinforcement learning. Science, 364(6443):859-865, 2019.
[15] Been Kim, Martin Wattenberg, Justin Gilmer, Carrie Cai, James Wexler, Fernanda Viegas, et al. Interpretability beyond feature attribution: Quantitative testing with concept activation vectors (TCAV). In 35th International Conference on Machine Learning (ICML), pages 2668-2677, 2018.
[16] Pieter-Jan Kindermans, Kristof T. Schütt, Maximilian Alber, Klaus-Robert Müller, D. Erhan, Been Kim, and Sven Dähne. Learning how to explain neural networks: PatternNet and PatternAttribution. In 6th International Conference on Learning Representations (ICLR), 2018.
[17] Maximilian Kohlbrenner, Alexander Bauer, Shinichi Nakajima, Alexander Binder, Wojciech Samek, and Sebastian Lapuschkin. Towards best practice in explaining neural network decisions with LRP. In 2020 International Joint Conference on NeuralNetworks (IJCNN), pages 1-7. IEEE, 2020.
[18] Sebastian Lapuschkin, Stephan Wäldchen, Alexander Binder, Grégoire Montavon, Wojciech Samek, and Klaus-Robert Müller. Unmasking clever hans predictors and assessing what machines really learn. Nature Communications, 10(1):1-8, 2019.
[19] Yann LeCun, Yoshua Bengio, and Geoffrey Hinton. Deep learning. Nature, 521(7553):436-444, 2015.
[20] Mengchen Liu, Jiaxin Shi, Zhen Li, Chongxuan Li, Jun Zhu, and Shixia Liu. Towards better analysis of deep convolutional neural networks. IEEE Transactions on Visualization and Computer Graphics (TVCG), 23(1):91-100, 2016.
[21] Aravindh Mahendran and Andrea Vedaldi. Understanding deep image representations by inverting them. In IEEE Conference on Computer Vision and Pattern Recognition (CVPR), pages 5188-5196, 2015.
[22] Grégoire Montavon, Alexander Binder, Sebastian Lapuschkin, Wojciech Samek, and Klaus-Robert Müller. Layer-Wise Relevance Propagation: An overview. In Explainable AI: Interpreting, Explaining and Visualizing Deep Learning, volume 11700 of Lecture Notes in Computer Science, pages 193-209. Springer, Cham, 2019.
[23] Grégoire Montavon, Sebastian Lapuschkin, Alexander Binder, Wojciech Samek, and Klaus-Robert Müller. Explaining nonlinear classification decisions with deep taylor decomposition. Pattern recognition, 65:211-222, 2017.
[24] Grégoire Montavon, Wojciech Samek, and Klaus-Robert Müller. Methods for interpreting and understanding deep neural networks. Digital Signal Processing, 73:1-15, 2018.
[25] Niels J S Morch, Ulrik Kjems, Lars Kai Hansen, Claus Svarer, lan Law, Benny Lautrup, Steve Strother, and Kelly Rehm. Visualization of neural networks using saliency maps. In ICNN'95-International Conference on Neural Networks, volume 4, pages 2085-2090. IEEE, 1995.
[26] Alexander Mordvintsev, Christopher Olah, and Mike Tyka. Inceptionism: Going deeper into neural networks. Google AI blog, 2015.
[27] W. James Murdoch, Peter J. Liu, and Bin Yu. Beyond word importance: Contextual decomposition to extract interactions from Istms. In 6th International Conference on Learning Representations (ICLR), 2018.
[28] Anh Nguyen, Alexey Dosovitskiy, Jason Yosinski, Thomas Brox, and Jeff Clune. Synthesizing the preferred inputs for neurons in neural networks via deep generator networks. Advances in Neural Information Processing Systems (NeurIPS), 29:3387-3395, 2016.
[29] Chris Olah, Alexander Mordvintsev, and Ludwig Schubert. Feature visualization. Distill, 2(11):e7, 2017.
[30] Adam Paszke, Sam Gross, Francisco Massa, Adam Lerer, James Bradbury, Gregory Chanan, Trevor Killeen, Zeming Lin, Natalia Gimelshein, Luca Antiga, et al. PyTorch: An imperative style, high-performance deep learning library. Advances in Neural Information Processing Systems (NeurIPS), 32, 2019.
[31] Rishi Rajalingham, Elias B Issa, Pouya Bashivan, Kohitij Kar, Kailyn Schmidt, and James J DiCarlo. Large-scale, high-resolution comparison of the core visual object recognition behavior of humans, monkeys, and state-of-the-art deep artificial neural networks. Journal of Neuroscience, 38(33):7255-7269, 2018.
[32] Marco Tulio Ribeiro, Sameer Singh, and Carlos Guestrin. “Why should I trust you?” Explaining the predictions of any classifier. In 22nd ACM SIGKDD International Conference on Knowledge Discovery and Data Mining, pages 1135-1144, 2016.
[33] Cynthia Rudin. Stop explaining black box machine learning models for high stakes decisions and use interpretable models instead. Nature Machine Intelligence, 1(5):206-215, 2019.
[34] Olga Russakovsky, Jia Deng, Hao Su, Jonathan Krause, Sanjeev Satheesh, Sean Ma, Zhiheng Huang, Andrej Karpathy, Aditya Khosla, Michael Bernstein, et al. ImageNet large scale visual recognition challenge. International Journal of Computer Vision, 115(3):211-252, 2015.
[35] Wojciech Samek, Grégoire Montavon, Sebastian Lapuschkin, Christopher J. Anders, and Klaus-Robert Müller. Explaining deep neural networks and beyond: A review of methods and applications. Proceedings IEEE, 109(3):247-278, 2021.
[36] Thomas Schnake, Oliver Eberle, Jonas Lederer, Shinichi Nakajima, Kristof T. Schütt, Klaus-Robert Müller, and Grégoire Montavon. XAI for graphs: Explaining graph neural network predictions by identifying relevant walks. arXiv preprint arXiv:2006.03589, 2020.
[37] Patrick Schramowski, Wolfgang Stammer, Stefano Teso, Anna Brugger, Franziska Herbert, Xiaoting Shao, Hans-Georg Luigs, Anne-Katrin Mahlein, and Kristian Kersting. Making deep neural networks right for the right scientific reasons by interacting with their explanations. Nature Machine Intelligence, 2(8):476-486, 2020.
[38] Andrew W Senior, Richard Evans, John Jumper, James Kirkpatrick, Laurent Sifre, Tim Green, Chongli Qin, Augustin Ždek, Alexander W R Nelson, Alex Bridgland, et al. Improved protein structure prediction using potentials from deep learning. Nature, 577(7792):706-710, 2020.
[39] Avanti Shrikumar, Peyton Greenside, and Anshul Kundaje. Learning important features through propagating activation differences. In 34th International Conference on Machine Learning (ICML), volume 70 of Proceedings of Machine Learning Research, pages 3145-3153, 2017.
[40] Jost Tobias Springenberg, Alexey Dosovitskiy, Thomas Brox, and Martin A. Riedmiller. Striving for simplicity: The all convolutional net. In 3rd International Conference on Learning Representations (ICLR), 2015.
[41] Pierre Stock and Moustapha Cisse. Convnets and ImageNet beyond accuracy: Understanding mistakes and uncovering biases. In European Conference on Computer Vision (ECCV), pages 498-512, 2018.
[42] Mukund Sundararajan, Ankur Taly, and Qiqi Yan. Axiomatic attribution for deep networks. In 34th International Conference on Machine Learning (ICML), pages 3319-3328, 2017.
[43] Christian Szegedy, Wojciech Zaremba, Ilya Sutskever, Joan Bruna, Dumitru Erhan, lan J. Goodfellow, and Rob Fergus. Intriguing properties of neural networks. In 2nd International Conference on Learning Representations (ICLR), 2014.
[44] Laurens Van der Maaten and Geoffrey Hinton. Visualizing data using t-sne. Journal of Machine Learning Research, 9(11), 2008.
[45] Chih-Kuan Yeh, Been Kim, Sercan Arik, Chun-Liang Li, Tomas Pfister, and Pradeep Ravikumar. On completeness-aware concept-based explanations in deep neural networks. Advances in Neural Information Processing Systems (NeurIPS), 33:20554-20565, 2020.
[46] Matthew D. Zeiler and Rob Fergus. Visualizing and understanding convolutional networks. In European Conference on Computer Vision (ECCV), volume 8689 of Lecture Notes in Computer Science, pages 818-833, Cham, 2014. Springer.
[47] Kauffmann, Jacob and Müller, Klaus-Robert and Montavon, Gregoire. Towards explaining anomalies: a deep Taylor decomposition of one-class models. In Pattern Recognition, Volume 101, page 107198, 2020.
[48] Kauffmann, Jacob and Esders, Malte and Montavon, Grégoire and Samek, Wojciech and Müler, Klaus-Robert. From clustering to cluster explanations via neural networks. arXiv preprint, arXiv:1906.07633, 2019.
[49] Montavon, Gregoire and Binder, Alexander and Lapuschkin, Sebastian and Samek, Wojciech and Müller, Klaus-Robert. Layer-wise relevance propagation: an overview, In Explainable AI: interpreting, explaining and visualizing deep learning, pages 193-209, 2019.

1. Apparatus, configured for
assigning a relevance score to a predictor portion, PP, of a machine learning, ML, predictor for performing an inference on a data structure, the relevance score indicating a share with which propagation paths, which connect the PP with a first predetermined PP of the ML predictor, contribute to an activation of the first predetermined PP, which activation is associated with the inference performed by the ML predictor on the data structure,
wherein the apparatus is configured for determining the relevance score for the PP by
performing a reverse propagation of an initial relevance score, which is attributed to the first predetermined PP, along the propagation paths, and
filtering the reverse propagation by weighting a first propagation path through the ML predictor, the first propagation path passing through a second predetermined PP of the ML predictor, differently than a second propagation path through the ML predictor, the second propagation path circumventing the second predetermined PP.

2. Apparatus according to claim 1, configured for filtering the reverse propagation by selectively taking into account propagation paths connecting the first predetermined PP and the PP, which propagation paths pass through the second predetermined PP.

3. Apparatus according to claim 1, wherein the initial relevance score is one of a predetermined value, and an activation of the first predetermined PP, which activation is associated with the inference performed by the ML predictor on the data structure.

4. Apparatus according to claim 1, wherein the second predetermined PP comprises one or more neurons of the ML predictor.

5. Apparatus according to claim 1, wherein, in performing an inference, the second predetermined PP is sensitive to a specific concept, which is potentially present in the content of the data structures.

6. Apparatus according to claim 1, wherein the apparatus is configured for
performing a reverse propagation from the first predetermined PP up to a set of PPs so as to acquire a PP relevance score for each of the PPs of the set of PPs;
determining the second predetermined PP based on the PP relevance scores for the set of PPs.

7. Apparatus according to claim 6, configured for determining the PP relevance score for each of the set of PPs by performing, in an unfiltered manner, a reverse propagation of the initial relevance score attributed to the first predetermined PP from the first predetermined PP through the ML predictor onto the PP.

8. Apparatus according to claim 6, configured for acquiring the second predetermined PP from the set of PPs by one or more of
ranking the PPs of the set of PPs according to their PP relevance scores and using one out of one or more highest ranked PPs as the second predetermined PP;
using an input received via a user interface for selecting the predetermined PP.

9. Apparatus according to claim 1, wherein the data structure is a digital image, and wherein the portion comprises a region within the digital image, or comprises one or more samples of the digital image.

10. Apparatus according to claim 1, configured for
filtering the reverse propagation by weighting a first propagation path through the ML predictor, the first propagation path passing through each of a plurality of predetermined PPs, which comprises the second predetermined PP, differently than a second propagation path through the ML predictor, the second propagation path circumventing at least one of the plurality of predetermined PPs.

11. Apparatus according to claim 1, wherein the first predetermined PP represents
a predictor output of the ML predictor, or
an intermediate predictor portion.

12. Apparatus according to claim 1, wherein the data structure is, or is a combination of,
a picture comprising a plurality of pixels, wherein the portion of the data structure corresponds to one or more of the pixels or subpixels of the picture, and/or
a video, wherein the portion of the data structure corresponds to one or more pixels or subpixels of pictures of the video, pictures of the video or picture sequences of the video, and/or
an audio signal, wherein the portion of the data structure corresponds to one or more audio samples of the audio signal, and/or
a feature map of local features or a transform locally or globally extracted from a picture, video or audio signal, wherein the portion of the data structure corresponds to local features, and/or
a text, wherein the portion of the data structure corresponds to words, sentences or paragraphs of the text, or wherein the portion of the data structure corresponds to tokens extracted from the text, and/or
a graph, such as a social network relations graph or a relational graph or a semantic graph, wherein the portion of the data structure corresponds to nodes or edges or sets of nodes or a set of edges or subgraphs.

13. Apparatus according to claim 1, configured for labelling the PP
as being affiliated to the second predetermined PP, and/or
as being associated with a concept represented by the second predetermined PP.

14. Apparatus according to claim 1, configured for
determining respective relevance scores of the PP with respect to a plurality of first predetermined PPs by performing respective reverse propagations of respective initial relevance scores attributed to the first predetermined PPs, and
ranking the first predetermined PPs according to the relevance scores determined for the PP with respect to the first predetermined PPs, and/or
selecting one or more first predetermined PPs out of the plurality of predetermined PPs based on the relevance scores determined for the PP with respect to the first predetermined PPs.

15. Apparatus according to claim 1, configured for pruning or altering or manipulating the ML predictor in dependence on the relevance score.

16. Apparatus according to claim 1, configured for
performing the inference for the data structure,
assigning the relevance score to the PP,
if the relevance score fulfils a predetermined criterion, performing a further inference for the data structure, wherein the apparatus is configured for deactivating or altering or manipulating the second predetermined PP in performing the further inference.

17. Apparatus, configured for
assigning a relevance score to a portion of a data structure, the relevance score rating a relevance of the portion for an inference performed by a machine learning predictor on the data structure, wherein the apparatus is configured for determining the relevance score for the portion by
performing a reverse propagation of an initial relevance score, which is attributed to a first predetermined predictor portion of the ML predictor, from the first predetermined PP through the ML predictor onto the portion of the data structure,
filtering the reverse propagation by weighting a first propagation path through the ML predictor, the first propagation path passing through a second predetermined PP of the ML predictor, differently than a second propagation path through the ML predictor, the second propagation path circumventing the second predetermined PP.

18. Apparatus according to claim 17, configured for generating a relevance map, which indicates, for a plurality of portions of the data structure, respective relevance scores with respect to the inference performed on the data structure.

19. Apparatus according to claim 17, configured for
determining respective relevance scores for a plurality of portions of the data structure, and
masking portions of the data structure depending on whether the respective relevance scores for the portions fulfill a condition.

20. Apparatus according to claim 17, configured for
assigning respective relevance scores to a plurality of portions of the data structure by performing the reverse propagation from the first predetermined PP to the data structure;
selecting a set of portions of the data structure out of the plurality of portions of the data structure based on the respective relevance scores.

21. Apparatus according to claim 17, configured for labelling the portion of the data structure
as being affiliated to the second predetermined PP, and/or
as being associated with a concept represented by the second predetermined PP.

22. Apparatus according to claim 17, configured for assigning respective relevance scores to portions of a data structure,
wherein the apparatus is part of a system, which further comprises an apparatus for processing of the data structure or data to be processed and derived from the data structure with adapting the processing depending on the relevance scores.

23. Apparatus according to claim 22, wherein the processing is a lossy processing and the apparatus for processing is configured to decrease a lossiness of the lossy processing for portions of the data structure having higher relevance scores assigned therewith than compared to portions of the data structure having lower relevance scores assigned therewith.

24. Apparatus according to claim 22, wherein the processing is a visualizing, wherein the apparatus for adapting is configured to perform a highlighting in the visualization depending on the relevance scores.

25. Apparatus according to claim 22, wherein the processing is a data replenishment by reading from memory or performing a further measurement wherein the apparatus for processing is configured to focus the data replenishment depending on the relevance scores.

26. Apparatus according to claim 1, configured for assigning respective relevance scores to portions of a data structure, and
wherein the apparatus is part of a system for highlighting a region of interest, the system further comprising an apparatus for generating a relevance graph depending on the relevance scores.

27. Apparatus according to claim 1, configured for assigning respective relevance scores to portions of a data structure;
wherein the apparatus is part of a system for optimizing a neural network, the system further comprising an apparatus for applying the apparatus for assigning onto a plurality of different data structures; and
an apparatus for detecting a portion of increased relevance within the neural network by accumulating relevances assigned to units of the ML predictor during the application of the apparatus for assigning onto the plurality of data structures, and optimizing the artificial neural network depending on the portion of increased relevance.

28. Apparatus, configured for
determining, for each out of a set of data structures, an affiliation score with respect to a concept associated with a predictor portion of a machine learning predictor by
determining a relevance score for the PP with respect to an inference performed by the ML predictor on the respective data structure, wherein the relevance score indicates a contribution of the PP to an activation of a first predetermined PP of the ML predictor, which activation is associated with the inference performed by the ML predictor on the data structure,
wherein the apparatus is configured for determining the relevance score by performing a reverse propagation of an initial relevance score from the first predetermined PP to the PP.

29. Apparatus according to claim 28, configured for
acquiring the PP of the ML predictor out of a set of PPs of the ML predictor based on respective relevance scores for the PPs of the set with respect to inferences performed on the set of data structures.

30. Apparatus according to claim 28, configured for selecting a subset of data structures out of the set of data structures based on the affiliation scores determined for the data structures.

31. Apparatus according to claim 30, configured for selecting the subset of data structures by
comparing the affiliation scores of the data structures to a threshold, or
ranking the data structures according to their affiliation scores, and selecting, out of the set of data structures, a predetermined number of data structures having the highest ranked affiliation scores.

32. Apparatus according to claim 30, configured for presenting the selected subset of data structures, or respective portions thereof, at a user interface.

33. Apparatus according to claim 30, wherein the PP is associated with a portion of the respective data structure, wherein the apparatus is configured for
for each of the selected subset of data structures, assigning respective relevance scores to a plurality portions of the respective data structure by performing the reverse propagation from the first predetermined PP to PPs associated with the portions of the data structure;
selecting a set of portions of the respective data structure out of the plurality of portions of the respective data structure based on the respective relevance scores.

34. Apparatus according to claim 30, configured for, for each of the selected subset of data structures, labelling the PP
as being affiliated to the first predetermined PP, and/or
as being associated with a concept represented by the first predetermined PP.

35. Apparatus according to claim 30, configured for
filtering the reverse propagation by weighting a first propagation path through the ML predictor, the first propagation path passing through a second predetermined PP of the ML predictor, differently than a second propagation path through the ML predictor, the second propagation path circumventing the second predetermined PP, and
for each of the selected subset of data structures, labelling the PP
as being affiliated to the first predetermined PP, and/or
as being associated with a concept represented by the first predetermined PP.

36. Apparatus according to claim 30, configured for
determining, for one of the selected data structures, an activation of the PP with respect to an inference on the data structure;
performing a reverse propagation of an initial relevance score derived from the activation of the PP, from the PP onto a further PP of the ML predictor.

37. Apparatus according to claim 28, configured for
filtering the reverse propagation by weighting a first propagation path through the ML predictor, the first propagation path passing through a second predetermined PP of the ML predictor, differently than a second propagation path through the ML predictor, the second propagation path circumventing the second predetermined PP.

38. Method, comprising:
assigning a relevance score to a portion of a data structure, the relevance score rating a relevance of the portion for an inference performed by a machine learning predictor on the data structure, wherein the method comprises determining the relevance score for the portion by
performing a reverse propagation of an initial relevance score, which is attributed to a first predetermined predictor portion of the ML predictor, from the first predetermined PP through the ML predictor onto the portion of the data structure,
filtering the reverse propagation by weighting a first propagation path through the ML predictor, the first propagation path passing through a second predetermined PP of the ML predictor, differently than a second propagation path through the ML predictor, the second propagation path circumventing the second predetermined PP.

39. Method, comprising:
assigning a relevance score to a predictor portion of a ML predictor for performing an inference on a data structure, the relevance score indicating a share with which propagation paths, which connect the PP with a first predetermined PP of the ML predictor, contribute to an activation of the first predetermined PP, which activation is associated with the inference performed by the ML predictor on the data structure,
wherein the method comprises determining the relevance score for the PP by
performing a reverse propagation of an initial relevance score, which is attributed to the first predetermined PP, along the propagation paths, and
filtering the reverse propagation by weighting a first propagation path through the ML predictor, the first propagation path passing through a second predetermined PP of the ML predictor, differently than a second propagation path through the ML predictor, the second propagation path circumventing the second predetermined PP.

40. Method, comprising:
determining, for each out of a set of data structures, an affiliation score with respect to a concept associated with a predictor portion of a machine learning predictor by
determining a relevance score for the PP with respect to an inference performed by the ML predictor on the respective data structure, wherein the relevance score indicates a contribution of the PP to an activation of a first predetermined PP of the ML predictor, which activation is associated with the inference performed by the ML predictor on the data structure,
wherein the method comprises determining the relevance score by performing a reverse propagation of an initial relevance score from the first predetermined PP to the PP.

41. A non-transitory digital storage medium having a computer program stored thereon to perform the method comprising:
assigning a relevance score to a portion of a data structure, the relevance score rating a relevance of the portion for an inference performed by a machine learning predictor on the data structure, wherein the method comprises determining the relevance score for the portion by
performing a reverse propagation of an initial relevance score, which is attributed to a first predetermined predictor portion of the ML predictor, from the first predetermined PP through the ML predictor onto the portion of the data structure,
filtering the reverse propagation by weighting a first propagation path through the ML predictor, the first propagation path passing through a second predetermined PP of the ML predictor, differently than a second propagation path through the ML predictor, the second propagation path circumventing the second predetermined PP
when said computer program is run by a computer.

42. A non-transitory digital storage medium having a computer program stored thereon to perform the method comprising:
assigning a relevance score to a predictor portion of a ML predictor for performing an inference on a data structure, the relevance score indicating a share with which propagation paths, which connect the PP with a first predetermined PP of the ML predictor, contribute to an activation of the first predetermined PP, which activation is associated with the inference performed by the ML predictor on the data structure,
wherein the method comprises determining the relevance score for the PP by
performing a reverse propagation of an initial relevance score, which is attributed to the first predetermined PP, along the propagation paths, and
filtering the reverse propagation by weighting a first propagation path through the ML predictor, the first propagation path passing through a second predetermined PP of the ML predictor, differently than a second propagation path through the ML predictor, the second propagation path circumventing the second predetermined PP
when said computer program is run by a computer.

43. A non-transitory digital storage medium having a computer program stored thereon to perform the method comprising:
determining, for each out of a set of data structures, an affiliation score with respect to a concept associated with a predictor portion of a machine learning predictor by
determining a relevance score for the PP with respect to an inference performed by the ML predictor on the respective data structure, wherein the relevance score indicates a contribution of the PP to an activation of a first predetermined PP of the ML predictor, which activation is associated with the inference performed by the ML predictor on the data structure,
wherein the method comprises determining the relevance score by performing a reverse propagation of an initial relevance score from the first predetermined PP to the PP,
when said computer program is run by a computer.
